(19) United States
(12) Patent Application Publication
(10) Pub. No.: US 2025/0145650 A1
(43) Pub. Date: May 8, 2025

(54) C1 Symmetric 5-OMe-6-alkyl Substituted Metallocenes

(71) Applicant: ExxonMobil Chemical Patents Inc., Baytown, TX (US)

(72) Inventors: Nikola S. Lambic, Seabrook, TX (US); Gregory J. Smith-Karahalis, Houston, TX (US)

(21) Appl. No.: 18/835,291

(22) PCT Filed: Jun. 30, 2023
(86) PCT No.: PCT/US2023/061530

§ 371 Date: Aug. 1, 2024

Related U.S. Application Data
(60) Provisional application No. 63/307,477, filed on Feb. 7, 2022.

(51) Int. Cl. C07F 17/00; C08F 10/06

(52) U.S. Cl. CPC C07F 17/00; C08F 10/06

(57) ABSTRACT

The 5-OMe-6-tBu substitution of the indenyl fragment of C₁ symmetric catalysts is critical for improvements in EP molecular weight capability. The catalysts described in this document are also capable of producing other ordinary polyolefins such as iPP, PE and EO copolymers. The added capability of high molecular weight EP copolymers may expand the potential of C₁ symmetric systems in the area of RCPs and ICPs where such capability is necessary.

### CROSS REFERENCE TO RELATED APPLICATIONS

This application claims the benefit of and priority to U.S. Provisional Application No. 63/307,477 filed Feb. 7, 2022, the disclosure of which is incorporated herein by reference.

### FIELD

The exemplary embodiments described herein relate to a polyolefin catalyst and a method for preparing a polyolefin by using same.

### BACKGROUND

Olefin polymerization catalysts are of great use in industry. Hence there is interest in finding new catalyst systems, including catalyst activators that increase the polymerization activity of the catalyst and allow the production of polymers having specific properties, such as high melting point and high molecular weight.

Catalysts for olefin polymerization are often based on metallocenes as catalyst precursors, which are activated either with the help of an alumoxane, or with an activator containing a non-coordinating anion.

Most, of patent publications employing the 4-Ar-5-OMe-6-tBu indene framework are based on C₂ symmetric metallocene systems. The first example of 4-Ar-5-OMe-6-tBu indene framework is described by Resconi in WO2007/116034 in the context of C₂ symmetric catalyst. Subsequent patent publications by Borealis describe the usage of 5-OMe-6-tBu indene framework (US 2014/0221584, US 2015/0259442, US 2016/0002369) in the context of symmetric (identically substituted indenes) and asymmetric (different indene substitution) metallocene catalysts of C₂ symmetry. Relevant publications are EP3567061A1, WO2019/12110A1, WO2020/02349A1, WO2019/197383A1, WO2020/157171A1.

Recent patent activities on C₁ symmetric catalysts for PP (WO2020/184887, US2019/0270833 and KR2019/0064338) use catalysts described in WO2014/099303 WO2017/069854 and U.S. Pat. No. 9,266,910B2. Other notable patent publications include KR2020/00041169, KR2020/2250792, KR2020/2250794, and WO2020/96250A1.

Other references of interest include U.S. Pat. Nos. 5,416,177; 5,817,590; 8,202,958; 8,076,419; 7,531,605; 7,741,417, 6,355,747; 7,851,644; 7,081,543; 6,342,566; 6,960,676; 6,384,142; 6,472,474; U.S. Patent Publication Nos. 2011/0172375 and 2010/0152388; EP Patent Publication Nos. 0 277 004, 0 405 201, 0 798 306, 0 630 910; PCT Publication Nos. WO 1991/002012, WO 2001/062764, WO 2001/068718, WO 2004/005360, WO 2001/048035, WO 2003/035708; M. A. Giardello, et al. (1995) J. Am. Chem. Soc., v. 117, pp. 12114-12129; and E. A. Sanginov, et al. (2006) Polymer Science, Series A, v. 48(2), pp. 99-106.

### SUMMARY

The 5-OMe-6-tBu substitution of the indenyl fragment of C₁ symmetric catalysts is critical for improvements in EP molecular weight capability. The catalysts described in this document are also capable of producing other ordinary polyolefins such as iPP, PE and EO copolymers. The added capability of high molecular weight EP copolymers may expand the potential of C₁ symmetric systems in the area of RCPs and ICPs where such capability is necessary.

### DRAWINGS

FIG. 1 is an X-ray structure from a catalyst embodying the present technological advancement.

FIG. 2 illustrates the average catalyst activities in propylene polymerization for conventional catalysts and catalysts embodying the present technological advancement.

FIGS. 3A and 3B illustrate average melting point and molecular weight capability of the polypropylenes prepared using conventional catalysts and catalysts embodying the present technological advancement.

FIGS. 4A and 4B illustrate average catalyst activities and molecular weight capability for PE/EO copolymers prepared using conventional catalysts and catalysts embodying the present technological advancement.

FIGS. 5A and 5B illustrate average melting point and average octene content in EO copolymers prepared using conventional catalysts and catalysts embodying the present technological advancement.

FIG. 6 illustrates representative catalyst activities for EP copolymers using conventional catalysts and catalysts embodying the present technological advancement.

FIGS. 7A and 7B illustrates representative ethylene incorporation and molecular weight capability of EP copolymers of various composition using conventional catalysts and catalysts embodying the present technological advancement.

FIG. 8 illustrates slurry polymerization in the presence propylene (iPP) and ethylene propylene mixture using conventional catalysts and catalysts embodying the present technological advancement.

FIGS. 9A and 9B illustrate molecular weight capability and composition of EP copolymers prepared in slurry polymerization using conventional catalysts and catalysts embodying the present technological advancement.

### DETAILED DESCRIPTION

For the purposes of this application and the claims thereto, the new numbering scheme for the Periodic Table Groups is used as described in Chemical and Engineering News, 63(5), p. 27 (1985). Therefore, a “Group 4 metal” is an element from Group 4 of the Periodic Table, e.g. Hf, Ti, or Zr.

Unless otherwise indicated, “catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat-1 hr-1. Unless otherwise indicated, “conversion” is the amount of monomer that is converted to polymer product, and is reported as mol % and is calculated based on the polymer yield and the amount of monomer fed into the reactor. Unless otherwise indicated, “catalyst activity” is a measure of how active the catalyst is and is reported as the mass of product polymer (P) produced per mole of catalyst (cat) used (kgP/molcat).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like. An oligomer is typically a polymer having a low molecular weight (such an Mn of less than 25,000 g/mol, preferably less than 2,500 g/mol) or a low number of mer units (such as 75 mer units or less). An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

For the purposes of this application, ethylene shall be considered an α-olefin.

For purposes of this application and claims thereto, the term “substituted” means that a hydrogen group has been replaced with a heteroatom, or a heteroatom containing group. For example, a “substituted hydrocarbyl” is a radical made of carbon and hydrogen where at least one hydrogen is replaced by a heteroatom or heteroatom containing group.

The term “heteroatom” refers to any group 13-17 element, excluding carbon. A heteroatom may include B, Si, Ge, Sn, N, P, As, O, S, Se, Te, F, Cl, Br, and I. The term “heteroatom” may include the aforementioned elements with hydrogens attached, such as BH, BH₂, SiH₂, OH, NH, NH₂, etc. The term “substituted heteroatom” describes a heteroatom that has one or more of these hydrogen atoms replaced by a hydrocarbyl or substituted hydrocarbyl group(s).

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where q is 1 to 10 and each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where q is 1 to 10 and each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

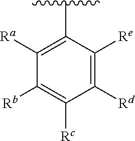

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is not H), or two or more of R^{a}, R^{b}, R^{c}, R^{d}, and R^{e} can be joined together to form a C₄-C₆₂ cyclic or polycyclic hydrocarbyl ring structure, or a combination thereof.

As used herein, Mn is number average molecular weight, Mw is weight average molecular weight, and Mz is z average molecular weight, wt % is weight percent, and mol % is mole percent. Molecular weight distribution (MWD), also referred to as polydispersity, is defined to be Mw divided by Mn. Unless otherwise noted, all molecular weight units (e.g., Mw, Mn, Mz) are g/mol.

The following abbreviations may be used herein: Me is methyl, Et is ethyl, Pr is propyl, cPR is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, Bn is benzyl, MAO is methylalumoxane, Ind is indenyl, Cp is cyclopentadienyl, Flu is fluorenyl, OTf is triflate, RT is room temperature (23° C., unless otherwise indicated).

A “catalyst system” is combination of at least one catalyst compound, at least one activator, an optional co-activator, and an optional support material. For the purposes of this application and the claims thereto, when catalyst systems are described as comprising neutral stable forms of the components, it is well understood by one of ordinary skill in the art, that the ionic form of the component is the form that reacts with the monomers to produce polymers.

In the description herein, the metallocene catalyst may be described as a catalyst precursor, a pre-catalyst compound, metallocene catalyst compound or a transition metal compound, and these terms are used interchangeably. A polymerization catalyst system is a catalyst system that can polymerize monomers to polymer. An “anionic ligand” is a negatively charged ligand which donates one or more pairs of electrons to a metal ion. A “neutral donor ligand” is a neutrally charged ligand which donates one or more pairs of electrons to a metal ion.

A metallocene catalyst is defined as an organometallic compound with at least one π-bound cyclopentadienyl moiety (or substituted cyclopentadienyl moiety) and more frequently two π-bound cyclopentadienyl moieties or substituted cyclopentadienyl moieties.

For purposes of this application and claims thereto in relation to metallocene catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group, ethyl alcohol is an ethyl group substituted with an —OH group.

The terms “hydrocarbyl radical,” “hydrocarbyl” and “hydrocarbyl group” are used interchangeably throughout this document. Likewise the terms “group”, “radical”, and “substituent” are also used interchangeably in this document. For purposes of this disclosure, “hydrocarbyl radical” is defined to be a radical, which contains hydrogen atoms and up to 100 carbon atoms and which may be linear, branched, or cyclic, and when cyclic, aromatic or non-aromatic. A “substituted hydrocarbyl” is a radical made of carbon and hydrogen where at least one hydrogen is replaced by a heteroatom or heteroatom containing group.

The 5-OMe-6-tBu substitution of the indenyl fragment of C₁ symmetric catalysts is critical for improvements in EP molecular weight capability. The catalysts described in this document are also capable of producing other ordinary polyolefins such as iPP, PE and EO copolymers. The added capability of high molecular weight EP copolymers may expand the potential of C₁ symmetric systems in the area of RCPs and ICPs where such capability is necessary.

Propylene-ethylene random copolymers and EP rubbers are of interest in the area of impact copolymers. However, C₁ metallocene catalysts typically fall short of achieving high molecular weight capability of the impact modifying phase such as EP rubber. In more general terms, metallocene catalysts that have high molecular weight capability typically involve sophisticated synthesis, as well as challenging rac/meso separations. Therefore, it is desired to have catalysts capable of producing both highly crystalline isotactic polypropylene and high molecular weight EP rubber with a cost efficient catalyst systems. One such catalyst compound disclosed herein is based on 5-OMe-6-tBu substitution on the C₁ symmetric scaffold as indicated below in Formula (I).

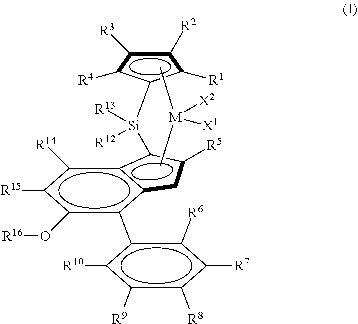

where:
M is a Group 4 metal, preferably Hf, Ti or Zr;
each of X¹ and X² is a univalent anionic ligand, or X¹ and X² are joined to form a metallocycle ring;
R¹-R⁴ is each independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′2, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R⁵ is hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R⁶—R¹⁰ is each independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R¹⁴ and R¹⁵ each independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R¹² and R¹³ are each independently an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is independently hydrogen, halogen, C₁-C₁₀ alkyl, or C₆-C₁₀ aryl;
optionally, R¹² and R¹³ may be joined; and
R¹⁶ is an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —R″—SiR′₃, wherein R″ is C₁-C₁₀ alkyl and each R′ is independently hydrogen, halogen, C₁-C₁₀ alkyl, or C₆-C₁₀ aryl.

Apart from providing high crystallinity iPP with minimal regioerrors, these catalysts are capable of producing high molecular weight EP copolymers with high activities and excellent ethylene incorporation (up to 50 wt %). Furthermore, the competency of these catalysts is also demonstrated on EO plastomers in this document. The anticipated application of these species is likely in production of random copolymer or impact copolymers with either stiff (iPP) or soft (RCP) matrix. The capability for production of these product compositions will be described in the future.

Examples of catalysts embodying the present technological advancement are as follows.

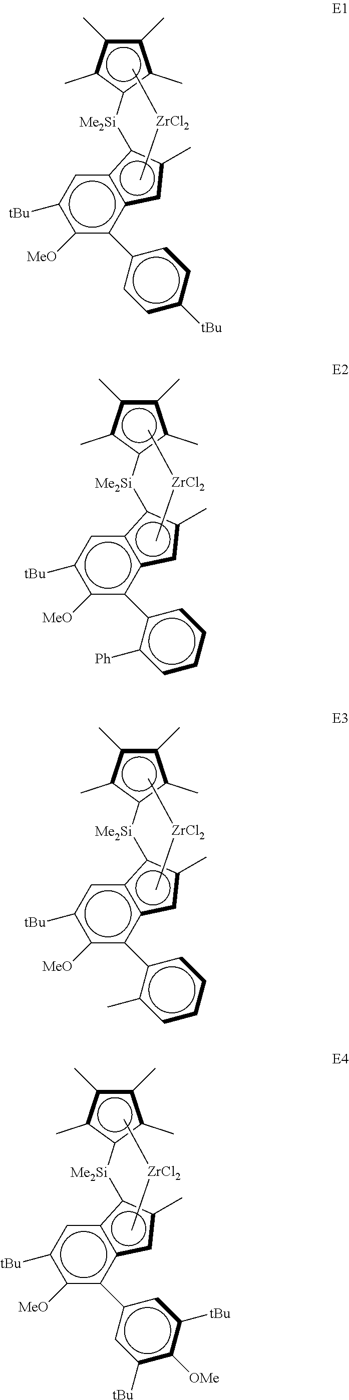

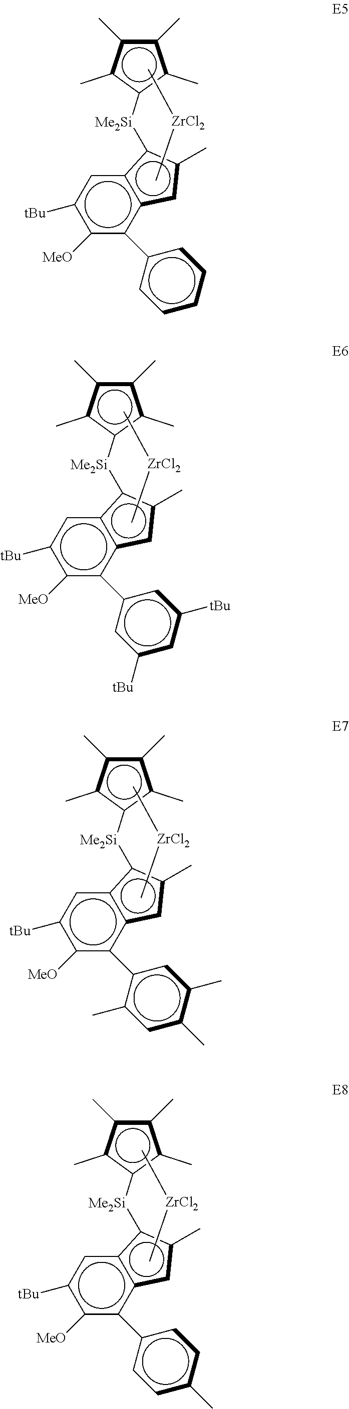

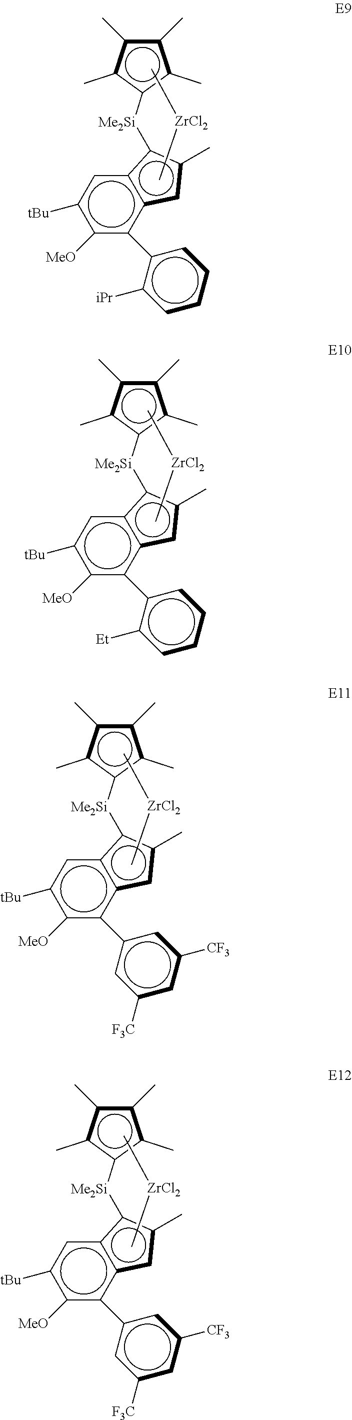

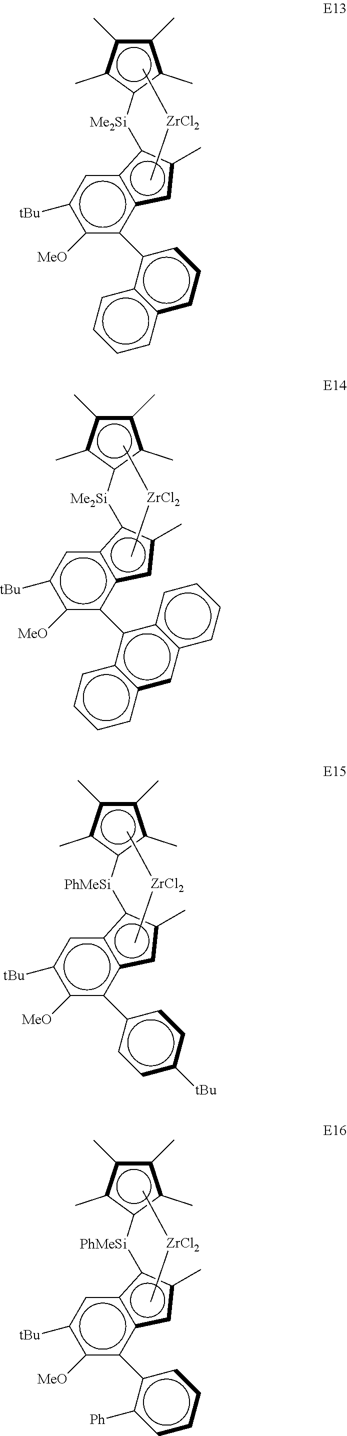

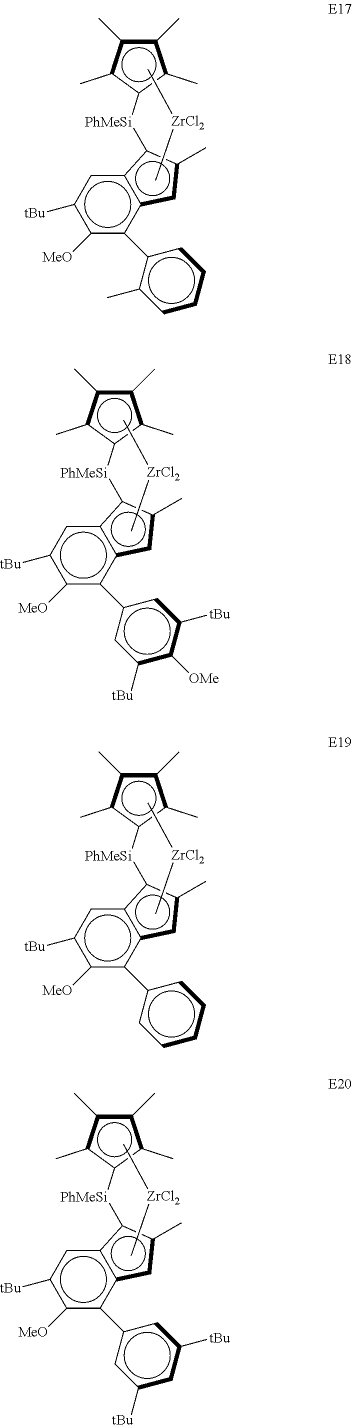

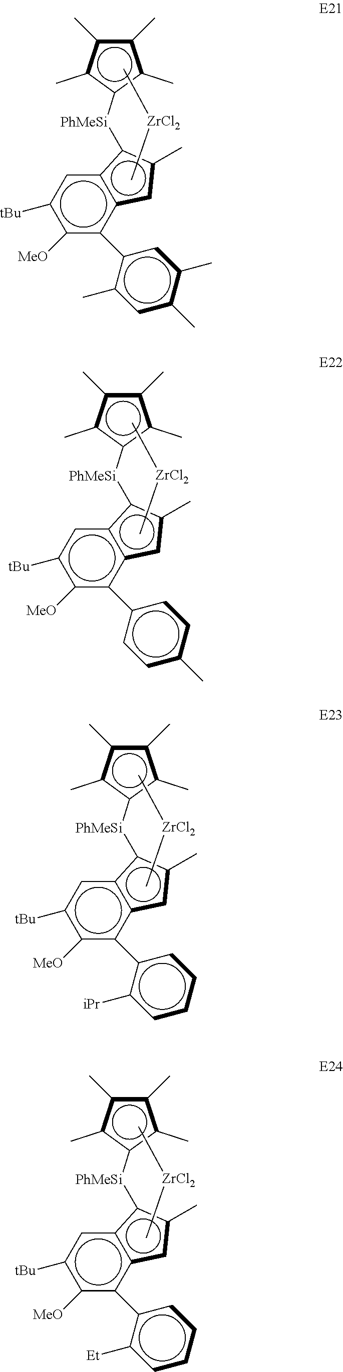

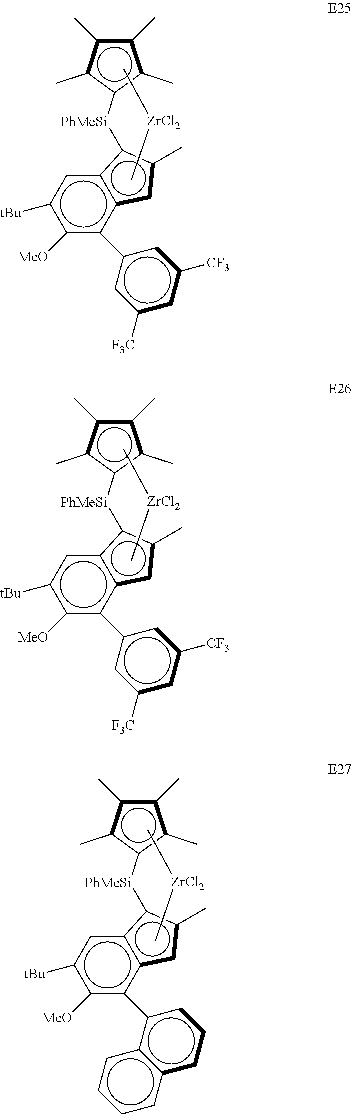

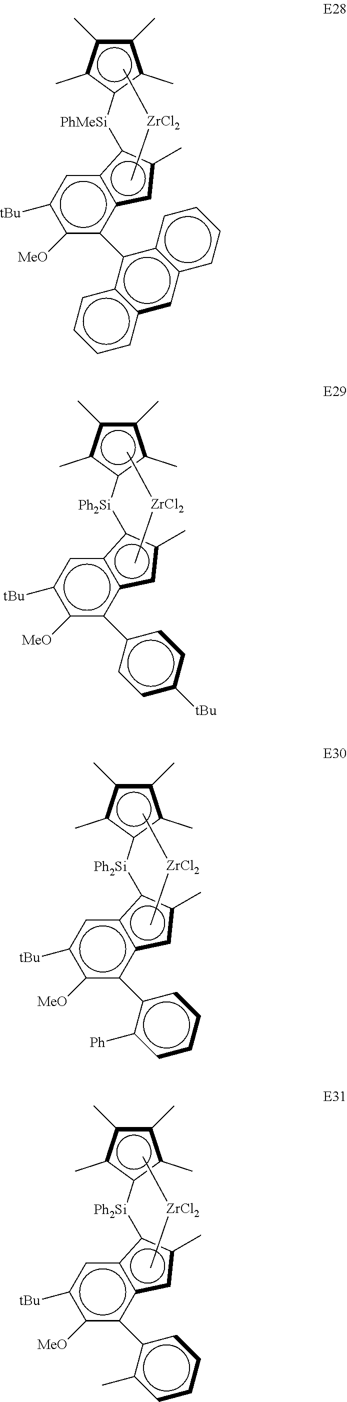

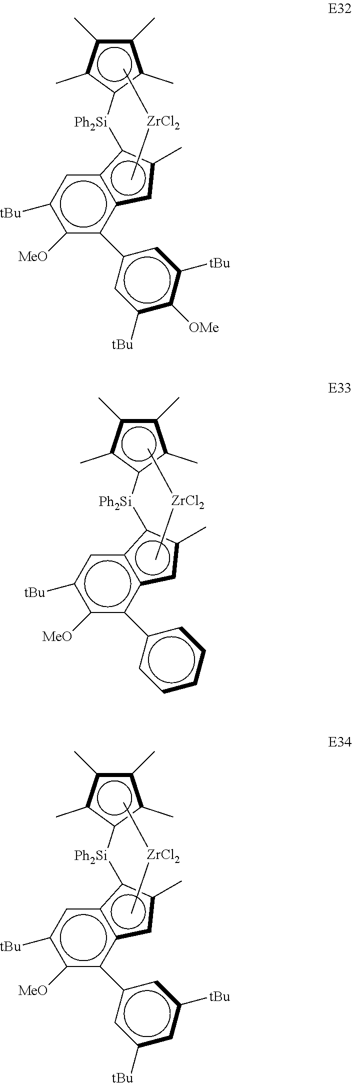

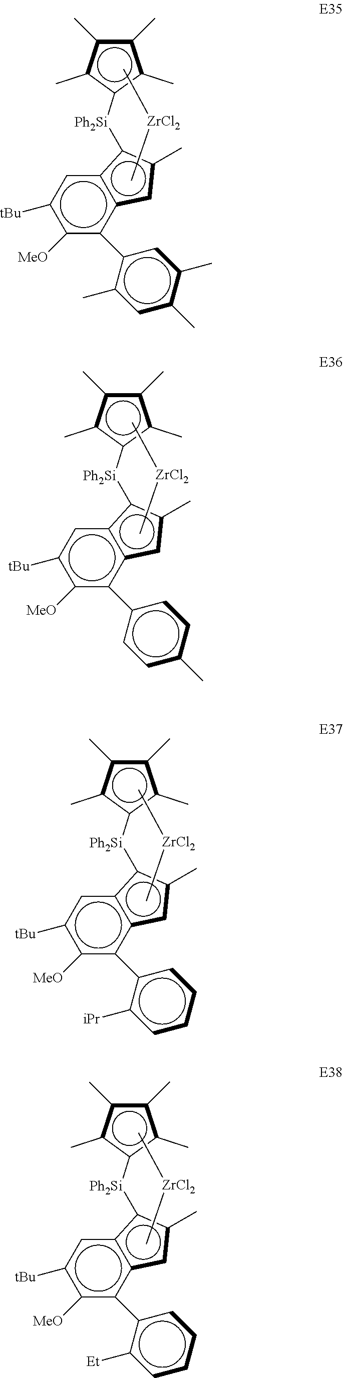

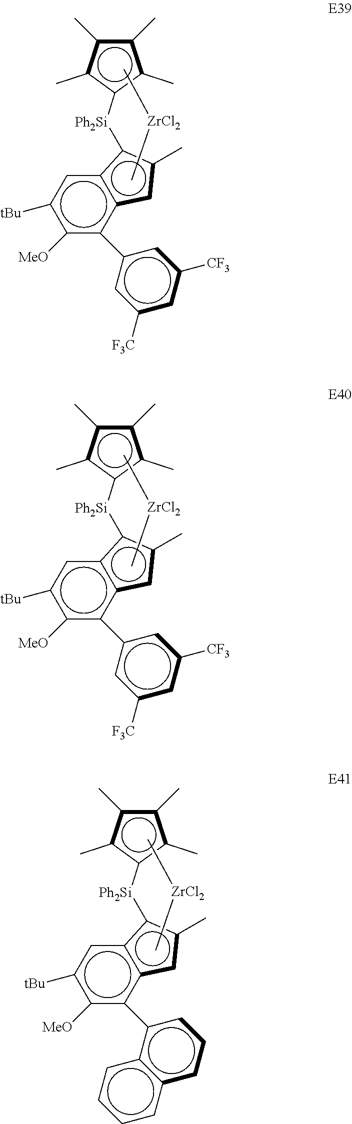

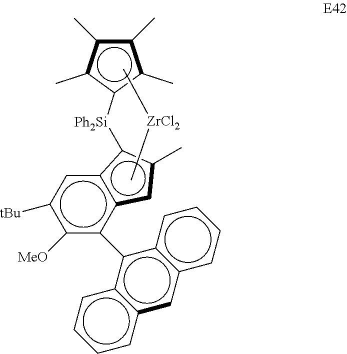

In this document, several conventional C₁ symmetric catalysts (C₁-C₆) are used as comparative examples against species E1-E4 that embody the present technological advancement.

Most commercial metallocene catalyst for polypropylene are based on C₂ symmetric metallocenes. These catalysts are highly active, but their cost-in-use is higher due to the need for complicated ligand syntheses and isomer resolution, which typically leads to lower yields. On the other hand, it would be advantageous to use a C₁ symmetric catalyst due to their ease of preparation and overall lower cost. This approach could, in theory, narrow the cost gap between ZN and metallocene catalysts. The structures of catalysts discussed in this document are shown below

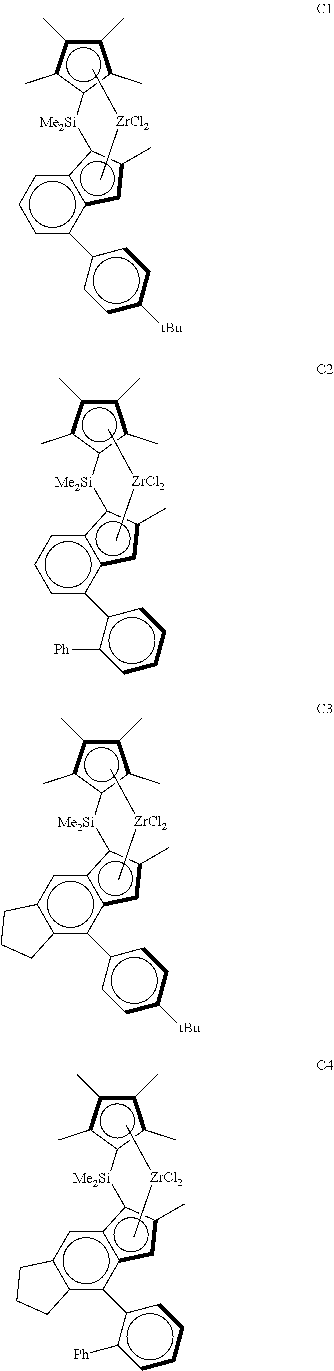

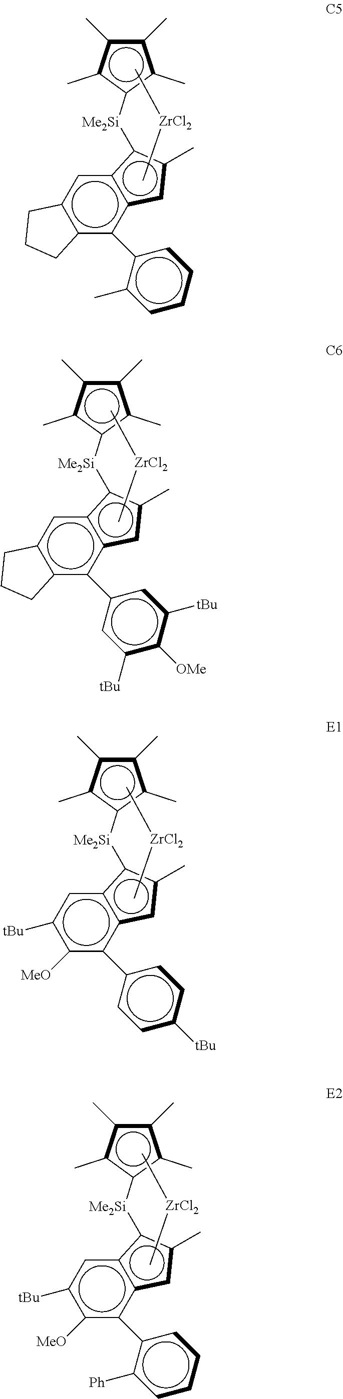

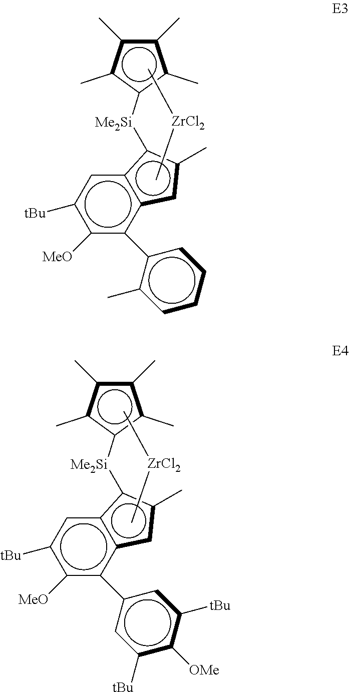

The new catalysts E1-E4 are prepared according to the following synthetic scheme for preparation of C₁ symmetric 5-OMe-6-tBu substituted metallocenes.

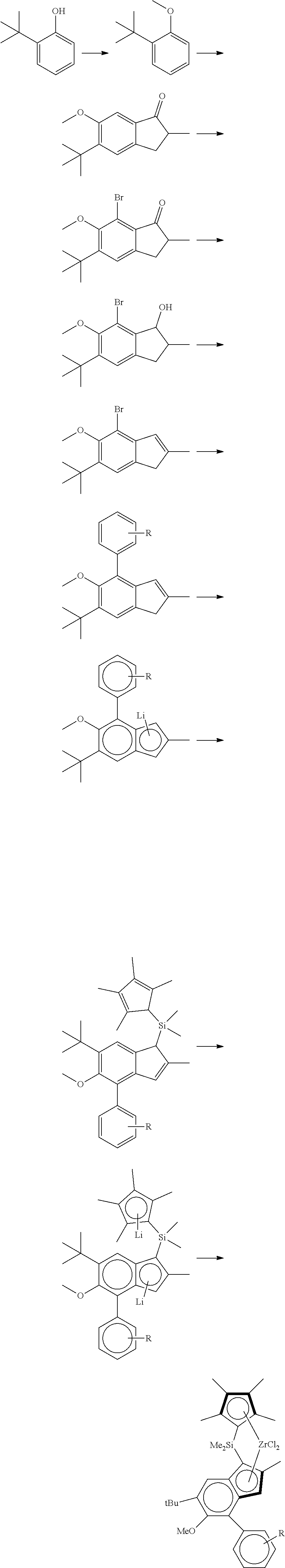

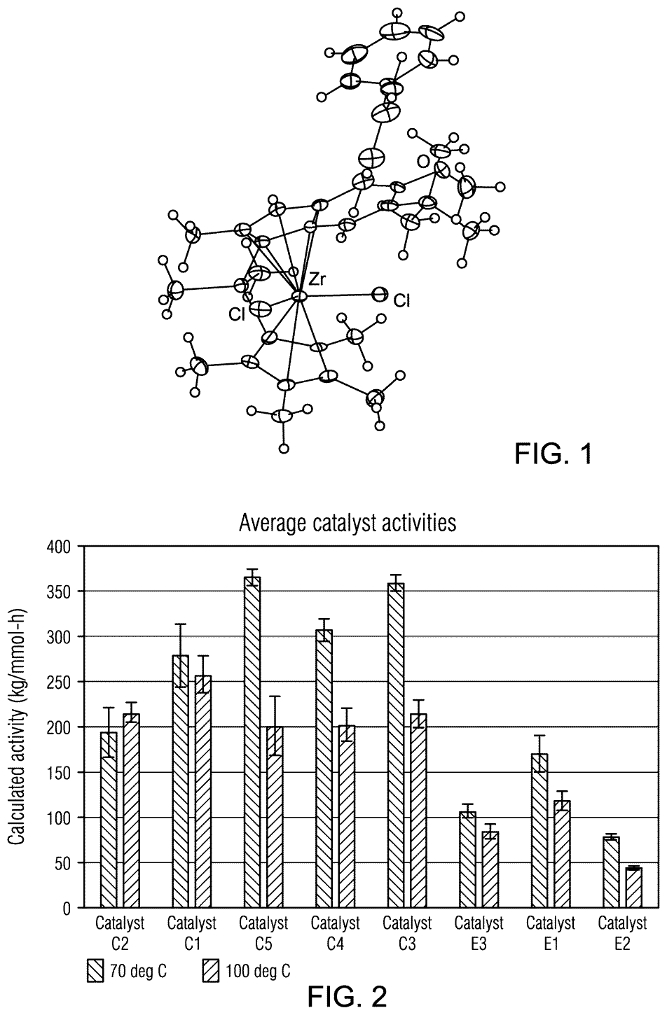

Slow evaporation of methylene chloride solution of catalyst E2 provided an X-ray quality crystal. The collected data confirms the expected ligand connectivity. The corresponding X-ray structure is shown in FIG. 1 (ellipsoids are at 50% probability level).

Catalysts E1-E3 were evaluated for propylene polymerization using MAO activator under high-throughput conditions with MAO activation (500 equiv.). FIG. 2 illustrates the average catalyst activities in propylene polymerization (conditions: [cat]=30 nmol, [MAO]=500 equiv. Polymerization carried out at 70 and 100° C.).

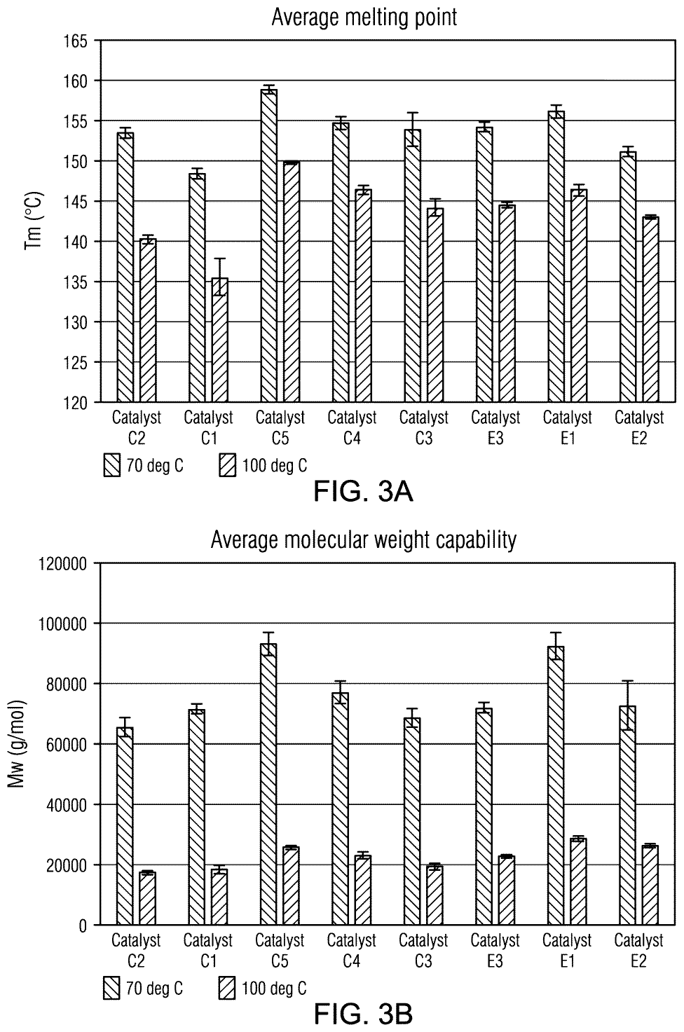

FIGS. 3A and 3B illustrate average melting point and molecular weight capability of the polypropylenes prepared using conventional catalysts and catalysts embodying the present technological advancement.

The activities of the catalysts embodying the present technological advancement is generally lower compared to the comparative catalysts from the same genus. However, the observed activities of >100 kg/mmol-h is still considered reasonably high. In addition, the catalysts embodying the present technological advancement deliver relatively high iPP crystallinity, with melting points exceeding 150° C. and Mw capability similar to other catalysts from the same genus. The high crystallinity of iPP is confirmed with ¹³C NMR data shown below in Table 1.

TABLE 1
¹³C NMR results for iPP produced at 70° C. and 100° C.

| | Tp = 70° C. | | | Tp = 100° C. | | |
|---|---|---|---|---|---|---|
| | | Total Stereo | Total | | Total | Total |
| Catalyst | mmmm | errors | regioerrors | mmmm | stereoerrors | regioerrors |
| Catalyst C2 | 0.920 | 196 | 0 | 0.822 | 420 | 0 |
| Catalyst C1 | 0.895 | 234 | 0 | 0.758 | 568 | 0 |
| Catalyst C5 | 0.960 | 83 | 0 | 0.881 | 273 | 0 |
| Catalyst C4 | 0.928 | 144 | 0 | 0.866 | 304 | 0 |
| Catalyst C3 | 0.943 | 124 | 7 | 0.879 | 300 | 0 |
| Catalyst E3 | 0.944 | 117 | 0 | 0.855 | 346 | 0 |
| Catalyst E1 | 0.957 | 89 | 8 | 0.898 | 225 | 0 |
| Catalyst E2 | 0.921 | 166 | 27 | 0.812 | 451 | 0 |

As indicated in Table 1, most catalysts retain high levels of catalyst stereo selectivity. For example, 4-tBu series of catalysts (C₁, C₃ and E1) show gradual improvements in stereo selectivity in going from simple indene to a more substituted 5-OMe-6-tBu indenes. As it is the case with previous systems, the choice of substituents of the 4-Ar moiety influences tacticity.

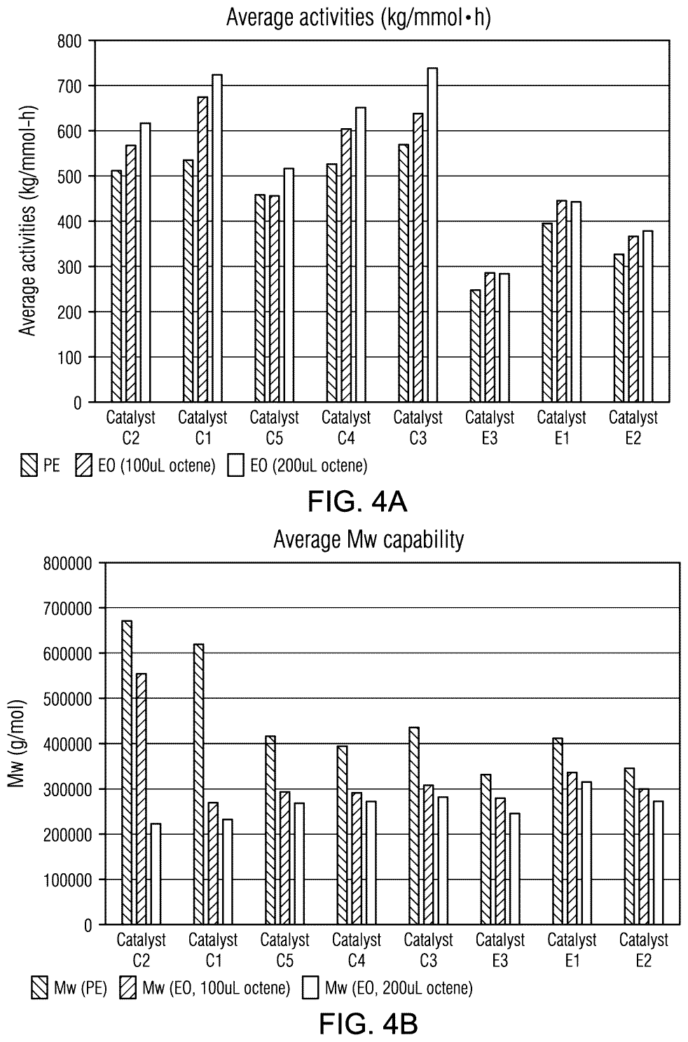

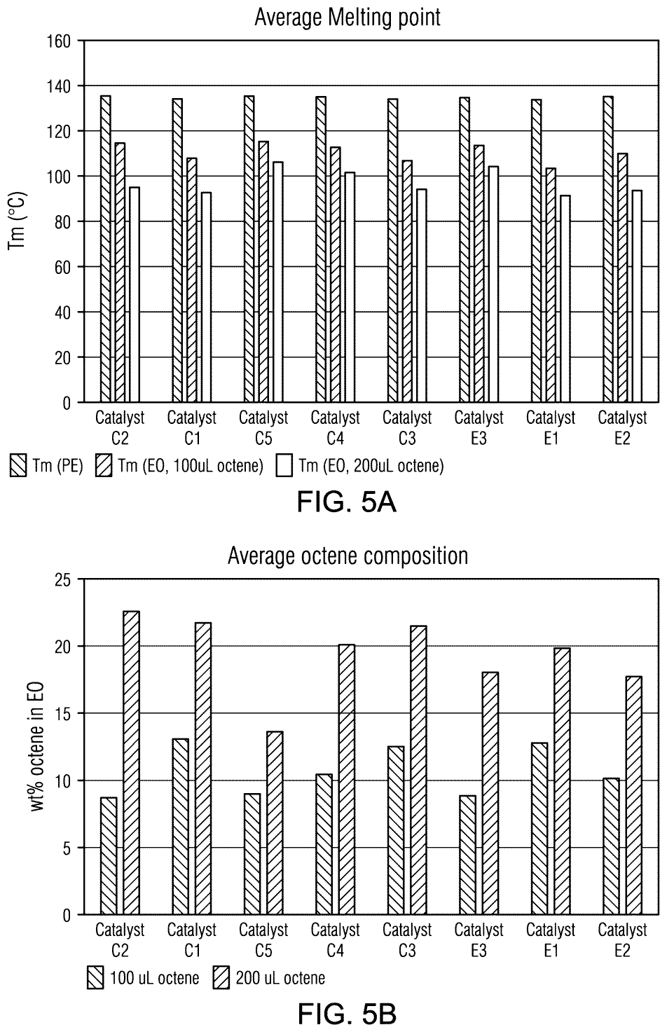

Ethylene and ethylene-octene (EO) copolymerization were carried out in high-throughput conditions with fixed ethylene pressure of 115 psi. FIGS. 4A and 4B illustrate average catalyst activities and molecular weight capability for PE/EO copolymers (condition: [cat]=20 nmol, 115 psi ethylene, 100° C.). FIGS. 5A and 5B illustrate average melting point and average octene content in EO.

The catalysts embodying the present technological advancement show slightly reduced activities compared to other C₁ symmetric catalysts and comparable Mw capability under most conditions. Octene composition remains comparable to other catalysts.

Ethylene propylene polymerization was carried out with varying amounts of propylene with balanced ethylene pressure such that a total pressure is 140 psi. Based on AVIATO calculations, the range of ethylene composition in the feed is approximately from 0.2-0.8 based on mol fractions relative to propylene. This type of screen allows for variety of compositions (semi-crystalline copolymers to pure EP rubbers). The results are described below. The catalysts E1-E3 are capable of producing variety of compositions under high activity (>200 kg/mmol-h). Comparable to other catalysts used in this document, the advantage of using 5-OMe-6-tBu substituted systems is in the significantly improved EP Mw capability. This is a major challenge for C₁ symmetric catalyst systems, which typically cannot achieve good Mw capability in ethylene copolymers. This capability may expand the usage of C₁ symmetric catalyst systems in the area that was typically not possible with previous C₁ symmetric catalyst families. With careful consideration of support, this may expand C₁ catalyst capability in specialty copolymer/impact-copolymer systems. Preferred supports may include Al2O3, ZrO2, SiO2, SiO2/Al2O3, SiO2/TiO2, silica clay, silicon oxide/clay, or mixtures thereof. The “careful” considerations of support influences what kind of process make specific polymers. For example, if one is looking to make impact copolymers, they would prefer a more porous support with high surface area. On the other hand, if one wants to make simple PPs for fibers or molded articles, they would consider a smaller particle size support with low pore content to help with volatiles.

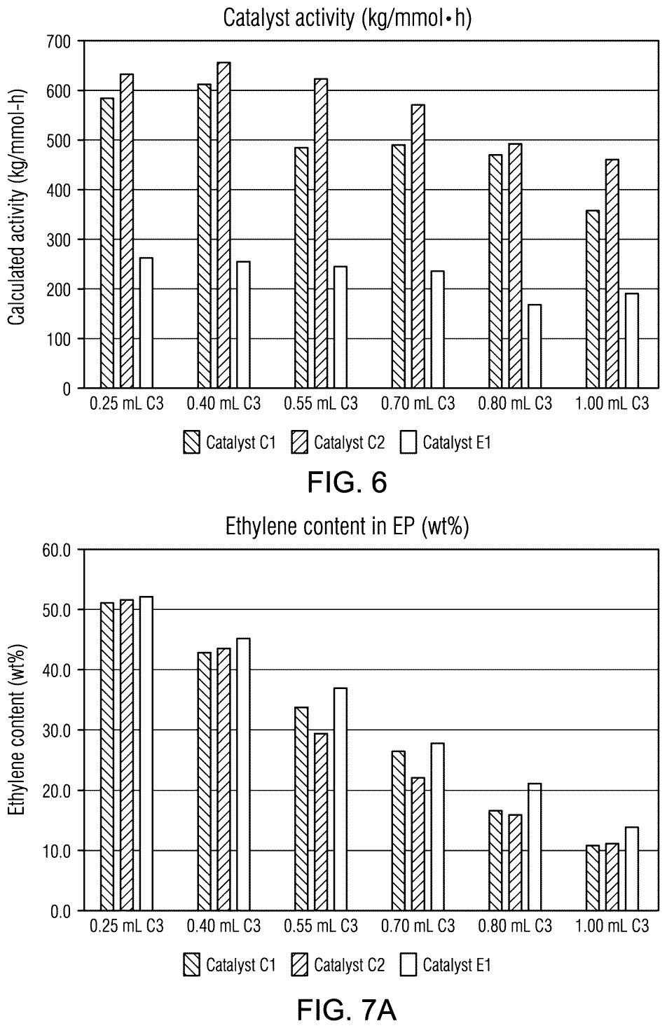

FIG. 6 illustrates representative catalyst activities for EP copolymers (conditions: [cat]20 nmol, 140 psi total pressure, 70° C.).

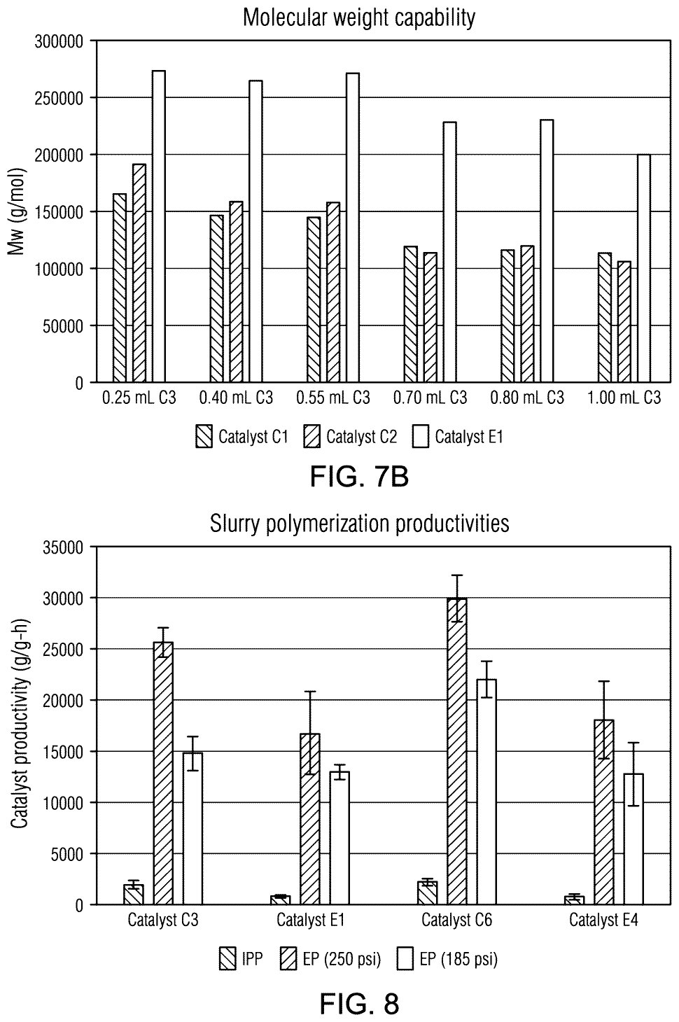

FIGS. 7A and 7B illustrate representative ethylene incorporation and molecular weight capability of EP copolymers of various composition.

Catalysts embodying the present technological advancement can also be supported on conventional porous materials such as silica. Details regarding supportation methods are described in the experimental section below. These supported catalysts show high activity as well as improved molecular weight capability of EP copolymers.

FIG. 8 illustrates slurry polymerization in the presence propylene (iPP) and ethylene propylene mixture (EP) (Conditions iPP: 0.6 mg supported catalyst, 5 μmol TIBAL, 4 mL of liquid propylene, 1 mL of isohexane. Conditions EP (250 psi) 0.6 mg supported catalyst, 5 μmol TIBAL, 2 mL of liquid propylene, 3 mL of isohexane, 70 psi ethylene. Conditions EP (185 psi) 0.6 mg supported catalyst, 5 μmol TIBAL, 1 mL of liquid propylene, 4 mL of isohexane 70 psi ethylene).

TABLE 2
Average polydispersity index (PDI) for polymers produced with
supported catalysts C3, C6, E1 and E4 in slurry polymerization

| Catalyst | PDI (iPP) | PDI (EP 250 psi) | PDI (EP 185 psi) |
|---|---|---|---|
| C3 | 2.48 | 2.23 | 2.07 |
| E1 | 2.05 | 2.10 | 1.95 |
| C6 | 2.25 | 2.35 | 2.25 |
| E4 | 1.98 | 2.20 | 2.00 |

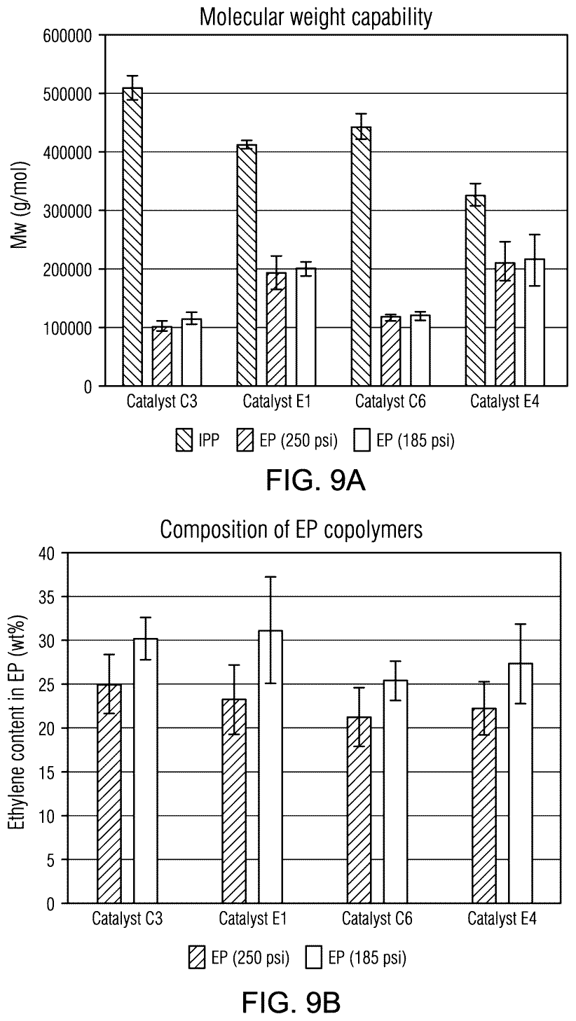

FIGS. 9A and 9B illustrate molecular weight capability and composition of EP copolymers prepared in slurry polymerization.

The data presented in FIGS. 7-9 indicates that supported catalysts E1-E4 embodying the present technological advancement demonstrate relatively high (>10,000 g/mol) catalyst activities for production of EP copolymers. The major advantage of usage of such systems is their improved molecular weight capability and narrower PDI in EP copolymers, which result in better quality rubbers providing improved impact properties. In addition, narrow polydispersity index (PDI) provided by catalysts E1-E4 is an extremely useful property in polypropylene fiber process.

The terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, 6-bound, metal ligand making the metal complex cationic and providing a charge-balancing noncoordinating or weakly coordinating anion. Those of ordinary skill in the art would be able to select an appropriate activator to use with the catalysts embodying the present technological advancement. Activators useable with the present technological advancement can be found in U.S. Pat. No. 9,266,910, the entirety of which is incorporated by reference herein. Preferred activators may include where activator is either aluminoxane or salts of non-coordinating (NCA) anions.

The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with this application are those that are compatible, stabilize the transition metal cation in the sense of balancing its ionic charge at +1, and yet retain sufficient lability to permit displacement during polymerization.

The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In embodiments herein, the catalyst system may comprise an inert support material. Preferably, the supported material is a porous support material, for example, talc, and inorganic oxides. Other support materials include zeolites, clays, organoclays, or any other organic or inorganic support material and the like, or mixtures thereof. Those of ordinary skill in the art would be able to select an appropriate support to use with the catalysts embodying the present technological advancement. Supports useable with the present technological advancement can be found in U.S. Pat. No. 9,266,910, the entirety of which is incorporated by reference herein. Preferred supports may include Al2O3, ZrO2, SiO2, SiO2/Al2O3, SiO2/TiO2, silica clay, silicon oxide/clay, or mixtures thereof.

In embodiments herein, the present technological advancement relates to polymerization processes where monomer (such as propylene), and, optionally, comonomer, are contacted with a catalyst system comprising an activator and at least one metallocene compound, as described above. The catalyst compound and activator may be combined in any order, and are combined typically prior to contacting with the monomer. The polymerization process useable with the present technological advancement can be found in U.S. Pat. No. 9,266,910, the entirety of which is incorporated by reference herein.

The present technological advancement also relates to compositions of matter produced by the methods described herein. The process of some embodiments of the present technological advancement produces olefin polymers, preferably polyethylene and polypropylene homopolymers and copolymers. In a one embodiment, the polymers produced herein are copolymers of ethylene preferably having from 0 to 25 mole % (alternately from 0.5 to 20 mole %, alternately from 1 to 15 mole %, preferably from 3 to 10 mole %) of one or more C₃ to C₂₀ olefin comonomer (preferably C₃ to C₁₂ alpha-olefin, preferably propylene, butene, hexene, octene, decene, dodecene, preferably propylene, butene, hexene, octene), or are copolymers of propylene preferably having from 0 to 25 mole % (alternately from 0.5 to 20 mole %, alternately from 1 to 15 mole %, preferably from 3 to 10 mole %) of one or more of C₂ or C₄ to C₂₀ olefin comonomer (preferably ethylene or C₄ to C₁₂ alpha-olefin, preferably ethylene, butene, hexene, octene, decene, dodecene, preferably ethylene, butene, hexene, octene).

Unless otherwise indicated Mw, Mn, MWD are determined by GPC as described in US 2006/0173123 pp. 24-25, paragraphs [0334] to [0341].

In a preferred embodiment of the present technological advancement, the propylene polymers produced may be isotactic polypropylene, atactic polypropylene and random, block or impact copolymers.

A process to prepare an alpha olefin homopolymer or copolymer by: introducing one or more of a C₂-C₄₀ olefin monomer, and a catalyst system including the catalyst compound of Formula (I), and optionally hydrogen into a reactor at a reactor pressure of from 0.7 bar to 70 bar and a reactor temperature of from 20° C. to 150° C.; and obtaining an alpha olefin homopolymer or copolymer. The C₂-C₄₀ comonomer can include of ethylene, propylene 1-butene, 1-pentene, 1-hexene, 2-methyl-1-pentene, vinylcyclobutane, 1-heptene, 1-octene, 1-decene, 1-dodecene, 1-tetradecene, 1-hexadecene, 1-octadecene, 1,5-hexadiene, 1,7-octadiene and 1,9-decadiene, norbornene, vinylnorbornene or ethylidine norbornene. The olefin polymer or copolymer can have a Mw value of 1,000 to 1,000,000 g/mol, such as from 5,000 to 500,000 such as from 10,000 to 250,000 as measured by gel permeation chromatography. The olefin homopolymer or copolymer can have a Mw distribution with polydispersity index less than 10, more preferably less than 6 and even more preferably less than 3. The propylene homopolymer and copolymer can have a melting point of greater than 120° C., more preferably greater than 140° C. and even more preferably greater than 150° C. The ethylene-propylene co-polymer can have comonomer content of 0.1-99.9 wt %, such as from 1 to 50 wt %, such as from 2 to 20 wt % such as from 3 to 10 wt %. The ethylene-linear alpha olefin co-polymer can have linear alpha olefin content comonomer content of 0.1-50 wt %, such as from 5 to 40 wt %, such as from 10 to 30 wt %.

### EXPERIMENTAL

### Preparation of dimethylsilyl (6-tert-butyl-4-(4-tert-butylphenyl)-5-methoxy-2-methylindenyl) (2,3,4,5-tetramethylcyclopentadienyl) zirconium dichloride (Catalyst E1)

### 5-Tert-butyl-7-(4-tert-butylphenyl)-6-methoxy-2-methylindene

To a sealable flask, 7-bromo-5-tert-butyl-6-methoxy-2-methylindene (0.791 g, 2.68 mmol), 4-tert-butylphenylboronic acid (0.480 g, 2.70 mmol, 1.01 equiv.), potassium carbonate (0.830 g, 6.01 mmol, 2.24 equiv.), bis(dibenzylideneacetone)palladium (0.020 g, 0.035 mmol, 0.013 equiv.), 1,3,5,7-tetramethyl-6-phenyl-2,4,8-trioxa-6-phosphaadamantane (0.030 g, 0.10 mmol, 0.038 equiv.), and tetrahydrofuran (30 mL) were added. Then, nitrogen-bubbled water (10 mL) was added. The sealable flask was put under a nitrogen atmosphere for 30 minutes, and then the flask was sealed. The sealed flask was stirred and heated to 75° C. for 16 hours. The reaction was then allowed to cool to room temperature. The contents of the flask were transferred to a separate flask and concentrated in vacuo. The residue was partitioned between water (50 mL) and diethyl ether (50 mL). The organic phase was isolated, and the aqueous phase was further extracted with diethyl ether (50 mL). The combined diethyl ether extracts were washed with saturated aqueous potassium carbonate (50 mL) and then brine (50 mL). The organic extract was dried over anhydrous magnesium sulfate and filtered over a pad of silica, washing product through the pad with additional diethyl ether (3×50 mL). The diethyl ether filtrate was concentrated in vacuo to give a yellow solid. The yellow solid was then dissolved in pentane (50 mL) and again filtered over a pad of silica, washing the product through the pad with additional pentane (3×50 mL). The pentane filtrate was concentrated in vacuo to afford the product as a white solid (0.544 g, 58% yield). ¹H NMR (400 MHz, C₆D₆): δ 7.47 (d, 2H, J=8.4 Hz), 7.41-7.33 (m, 3H), 6.43 (d, 1H, J=2.2 Hz), 3.24 (s, 3H), 2.98 (s, 2H), 1.84 (s, 3H), 1.59 (s, 9H), 1.28 (s, 9H).

### (6-(tert-butyl)-4-(4-(tert-butyl)phenyl)-5-methoxy-2-methyl-1H-inden-1-yl)dimethyl(2,3,4,5-tetramethylcyclopenta-2,4-dien-1-yl)silane

To a precooled, stirring solution of 5-tert-butyl-7-(4-tert-butylphenyl)-6-methoxy-2-methylindene (0.544 g, 1.56 mmol) in diethyl ether, n-butyllithium (0.60 mL, 2.74M in hexane, 1.6 mmol, 1.05 equiv.) was added. The reaction was stirred at room temperature for 16 hours. The reaction was concentrated under a stream of nitrogen and then under high vacuum to afford the lithiate as a white solid. The lithiate was dissolved in diethyl ether (40 mL). This solution was then added to a stirring solution of tetramethylcyclopentadienyldimethylsilyl trifluoromethanesulfonate (0.425 g, 1.56 mmol, 1 equiv.) in diethyl ether. The reaction was stirred at room temperature for 1 hour. The reaction was concentrated under a stream of nitrogen and then under high vacuum. The residue was extracted with pentane (3×20 mL) and filtered over Celite. The combined pentane extracts were concentrated under a stream of nitrogen and then under high vacuum to afford the product as a white foam (0.615 g, 75% yield). ¹H NMR (400 MHz, C₆D₆): δ 7.70 (d, 2H, J=8.4 Hz), 7.61 (s, 1H), 7.43 (d, 2H, J=8.4 Hz), 6.67 (s, 1H), 3.25 (s, 3H), 2.00 (s, 3H), 1.97 (s, 3H), 1.91 (s, 3H), 1.82 (s, 6H), 1.63 (s, 9H), 1.31 (s, 9H), −0.08 (s, 3H), −0.17 (s, 3H).

### Lithium 6-(tert-butyl)-4-(4-(tert-butyl)phenyl)-1-(dimethyl(2,3,4,5-tetramethylcyclo penta-2,4-dien-1-ide-1-yl)silyl)-5-methoxy-2-methyl-1H-inden-1-ide

To a stirring solution of (6-(tert-butyl)-4-(4-(tert-butyl)phenyl)-5-methoxy-2-methyl-1H-inden-1-yl)dimethyl(2,3,4,5-tetramethylcyclopenta-2,4-dien-1-yl)silane (0.615 g, 1.17 mmol) in diethyl ether (50 mL), n-butyllithium (0.90 mL, 2.74M in hexane, 2.5 mmol, 2.1 equiv.) was added. The reaction was stirred at room temperature for 2 hours. The reaction was concentrated under a stream of nitrogen and then under high vacuum. The residue was washed with pentane (10 mL) and filtered over a plastic, fritted funnel. The filtered solid was collected and concentrated under high vacuum to afford the product as a light orange solid (0.366 g, 58% yield). ¹H NMR (400 MHz, THF-d8): δ 7.58 (d, 2H, J=8.4 Hz), 7.49 (s, 1H), 7.37 (d, 2H, J=8.4 Hz), 5.74 (s, 1H), 3.11 (s, 3H), 2.31 (s, 3H), 2.15 (s, 6H), 1.93 (s, 6H), 1.38 (s, 9H), 1.37 (s, 9H), 0.60 (s, 6H).

### Dimethylsilyl (6-tert-butyl-4-(4-tert-butylphenyl)-5-methoxy-2-methylindenyl) (2,3,4,5-tetramethylcyclopentadienyl) zirconium dichloride (catalyst E1)

To a stirring solution of lithium 6-(tert-butyl)-4-(4-(tert-butyl)phenyl)-1-(dimethyl(2,3,4,5-tetramethylcyclopenta-2,4-dien-1-ide-1-yl)silyl)-5-methoxy-2-methyl-1H-inden-1-ide (0.366 g, 0.679 mmol) in diethyl ether (50 mL), zirconium chloride (0.155 g, 0.665 mmol, 0.979 equiv.) was added, washing residual zirconium chloride into the reaction with toluene (5 mL). The reaction was stirred at room temperature 15 hours. The reaction was concentrated under a stream of nitrogen and then under high vacuum. The residue was extracted with dichloromethane (2×20 mL) and filtered over Celite. The combined dichloromethane extracts were concentrated under a stream of nitrogen and then under high vacuum to give a sticky orange foam (0.443g). The foam was stirred in pentane (20 mL) for 1 hour, resulting in a yellow suspension. The suspension was filtered over a plastic, fritted funnel. The filtered solid was collected and concentrated under high vacuum to afford the product as a yellow solid (0.253 g, 54% yield). ¹H NMR (400 MHz, CD₂Cl₂): δ 7.60-7.52 (m, 2H), 7.52-7.46 (m, 2H), 7.44 (s, 1H), 6.62 (s, 1H), 3.32 (s, 3H), 2.20 (s, 3H), 2.05 (s, 3H), 1.98 (s, 3H), 1.90 (s, 3H), 1.89 (s, 3H), 1.37 (s, 9H), 1.35 (s, 9H), 1.19 (s, 3H), 1.08 (s, 3H).

### Preparation of dimethylsilyl (6-tert-butyl-5-methoxy-2-methyl-4-(o-tolyl)-indenyl) (2,3,4,5-tetramethylcyclopentadienyl) zirconium dichloride (Catalyst E3) 5-tert-butyl-6-methoxy-2-methyl-7-(o-tolyl)-indene

To a sealable flask, 7-bromo-5-tert-butyl-6-methoxy-2-methylindene (0.776 g, 2.63 mmol), o-tolylboronic acid (0.357 g, 2.63 mmol, 1 equiv.), potassium carbonate (0.799 g, 5.78 mmol, 2.2 equiv.), bis(dibenzylideneacetone)palladium (0.015 g, 0.026 mmol, 0.01 equiv.), 1,3,5,7-tetramethyl-6-phenyl-2,4,8-trioxa-6-phosphaadamantane (0.023 g, 0.079 mmol, 0.03 equiv.), and tetrahydrofuran (30 mL) were added. Then, nitrogen-bubbled water (10 mL) was added. The sealable flask was put under a nitrogen atmosphere for 30 minutes, and then the flask was sealed. The sealed flask was stirred and heated to 80° C. for 17 hours. The reaction was then allowed to cool to room temperature. The contents of the flask were transferred to a separate flask and concentrated in vacuo. The residue was partitioned between water (50 mL) and pentane (100 mL). The aqueous layer was drained, and then organic layer was washed with saturated aqueous potassium carbonate and then brine. The organic extract was dried over anhydrous magnesium sulfate and filtered over a pad of silica, washing product through with additional pentane (3×50 mL). The pentane filtrate was concentrated in vacuo to afford the product as a white solid (0.460 g, 57% yield, mixture of two isomers, 0.16:1 ratio). ¹H NMR (400 MHz, C₆D₆): Major isomer δ 7.37 (s, 1H), 7.22-7.05 (m, 4H), 6.43 (q, 1H, J=1.5 Hz), 3.19 (s, 3H), 2.98 (dt, 1H, J=22.7, 1.1 Hz), 2.66 (dt, 1H, J=22.5, 1.3 Hz), 2.17 (s, 3H), 1.83 (d, 3H, J=1.5 Hz), 1.56 (s, 9H).

### Lithium 6-tert-butyl-4-(o-tolyl)-5-methoxy-2-methylindenide

To a precooled, stirring solution of 5-tert-butyl-6-methoxy-2-methyl-7-(o-tolyl)-indene (0.460 g, 1.50 mmol) in diethyl ether (50 mL), n-butyllithium (0.60 mL, 2.74M in hexane, 1.6 mmol, 1.1 equiv.) was added. The reaction was stirred at room temperature for 16 hours. The reaction was concentrated under a stream of nitrogen and then under high vacuum. The residue was washed with hexane (10 mL) and filtered over a plastic, fritted funnel. The filtered solid was collected and concentrated under high vacuum to afford the product as a white solid (0.469 g, 64% yield). ¹H NMR (400 MHz, C4D8O): δ 7.45-7.39 (m, 1H), 7.24-7.20 (m, 1H), 7.18 (s, 1H), 7.15-7.09 (m, 2H), 5.70 (d, 1H, J=2.0 Hz), 5.25 (d, 1H, J=2.1 Hz), 3.16 (s. 3H), 2.25 (s, 3H), 2.20 (s, 3H), 1.42 (s, 9H).

### (6-(Tert-butyl)-5-methoxy-2-methyl-4-(o-tolyl)-1H-inden-1-yl)dimethyl(2,3,4,5-tetra methylcyclopenta-2,4-dien-1-yl)silane

To a stirring solution of lithium 6-tert-butyl-5-methoxy-2-methyl-4-(o-tolyl)-indenide (0.298 g, 0.954 mmol) in diethyl ether (50 mL), tetramethylcyclopentadienyldimethylsilyl trifluoromethanesulfonate (0.313 g, 0.954 mmol, 1 equiv.) was added. The reaction was stirred at room temperature for 3 hours. The reaction was concentrated under a stream of nitrogen and then under high vacuum. The residue was extracted with pentane (3×20 mL) and filtered over Celite. The combined pentane extracts were concentrated under a stream of nitrogen and then under high vacuum to afford the product as a white foam (0.399 g, 86% yield, two isomers, 1:1.8 isomer ratio). ¹H NMR (400 MHz, C₆D₆): Integrated as combined isomers 6 7.62/7.61 (s, 1H), 7.54-7.44 (m, 1H), 7.27-7.17 (m, 3H), 6.36/6.31 (s, 1H), 3.62/3.54 (s, 1H), 3.24 (br s, 1H), 3.20/3.19 (s, 3H), 2.30/2.29 (s, 3H), 1.98/1.97 (s, 6H), 1.90 (s, 3H), 1.83 (s, 6H), 1.600/1.596 (s, 9H), −0.10/−0.16 (s, 3H), −0.19/−0.22 (s, 3H).

### Dimethylsilyl (6-tert-butyl-5-methoxy-2-methyl-4-(o-tolyl)-indenyl) (2,3,4,5-tetramethyl cyclopentadienyl) zirconium dichloride (Catalyst E3)

To a stirring solution of (6-(tert-butyl)-5-methoxy-2-methyl-4-(o-tolyl)-1H-inden-1-yl)dimethyl(2,3,4,5-tetramethylcyclopenta-2,4-dien-1-yl)silane (0.399 g, 0.823 mmol) in diethyl ether, n-butyllithium (0.61 mL, 2.74M in hexane, 1.7 mmol, 2 equiv.) was added. The reaction was stirred at room temperature for 16 hours. The reaction was concentrated under a stream of nitrogen and then under high vacuum. The residue was washed with pentane (10 mL) and filtered over a plastic, fritted funnel. The solid was collected and concentrated under high vacuum to give a pink solid. The pink solid was dissolved in diethyl ether (50 mL), and zirconium chloride (0.192 g, 0.823 mmol, 1 equiv.) was added to the solution with stirring, washing residual zirconium chloride into the reaction with toluene (5 mL). The reaction as stirred at room temperature overnight. The reaction was concentrated under a stream of nitrogen and then under high vacuum. The residue was extracted with dichloromethane (3×20 mL) and filtered over Celite. The combined dichloromethane extracts were concentrated under a stream of nitrogen and then under high vacuum. This residue was stirred in pentane (10 mL) until a suspension formed. The resulting suspension was filtered over a plastic, fritted funnel. The filtered solid was collected and concentrated under high vacuum to afford the product as a yellow solid (0.181 g, 34% yield, 1:1.7 ratio of isomers A and B). ¹H NMR (400 MHz, CD₂Cl₂): Isomers integrated in total 6 7.76-7.70 (m, 1H), 7.46 (s, 1H), 7.44 (s, 1H), 7.36-7.14 (m, 6H), 7.02 (dd, 1H, J=7.6, 1.5 Hz), 6.47 (s, 1H, used for ratio calculation, isomer B), 6.36 (s, 1H used for ratio calculation, isomer A), 3.34 (s, 3H), 3.31 (s, 3H), 2.57 (s, 3H), 2.20 (s, 3H), 2.18 (s, 3H), 2.07 (s, 3H), 2.044 (s, 3H), 2.037 (s, 3H), 1.98 (s, 6H), 1.95 (s, 3H), 1.92 (s, 3H), 1.91 (s, 3H), 1.90 (s, 3H), 1.36 (s, 9H), 1.35 (s, 9H), 1.19 (s, 3H), 1.18 (s, 3H), 1.08 (s, 3H), 1.07 (s, 3H).

### Preparation of dimethylsilyl (4-(o-biphenyl)-6-tert-butyl-5-methoxy-2-methylindenyl) (2,3,4,5-tetramethylcyclopentadienyl) zirconium dichloride (Catalyst E2) 7-(o-biphenyl)-5-tert-butyl-6-methoxy-2-methylindene

To a sealable flask, 7-bromo-5-tert-butyl-6-methoxy-2-methylindene (0.812 g, 2.75 mmol), o-biphenylboronic acid (0.545 g, 2.75 mmol, 1 equiv.), potassium carbonate (0.836 g, 6.05 mmol, 2.2 equiv.), bis(dibenzylideneacetone)palladium (0.016 g, 0.028 mmol, 0.01 equiv.), 1,3,5,7-tetramethyl-6-phenyl-2,4,8-trioxa-6-phosphaadamantane (0.024 g, 0.083 mmol, 0.03 equiv.), and tetrahydrofuran (30 mL) were added. Then, nitrogen-bubbled water (10 mL) was added. The sealable flask was put under a nitrogen atmosphere for 30 minutes, and then the flask was sealed. The sealed flask was stirred and heated to 80° C. for 65 hours. The reaction was then allowed to cool to room temperature. The contents of the flask were transferred to a separate flask and concentrated in vacuo. The residue was partitioned between water (100 mL) and diethyl ether (100 mL). The aqueous layer was drained, and the diethyl ether layer was collected. The aqueous layer was extracted further with diethyl ether (2×50 mL). The combined diethyl ether extracts were washed with saturated aqueous potassium carbonate and then brine. The organic extract was dried over anhydrous magnesium sulfate and concentrated in vacuo to give an orange solid. The solid was dissolved in pentane (50 mL) and filtered over a pad of silica. The product was further washed through the silica pad with additional pentane (3×50 mL) and then a mixture of diethyl ether and pentane (diethyl ether to pentane ratio was 1:5, using 3×50 mL of the mixture). The combined filtrate was concentrated in vacuo to afford the product as an off-white to yellow solid (0.964 g, 95% yield, 1:20 ratio of isomers). ¹H NMR (400 MHz, C6D6): Major isomer δ 7.49-7.44 (m, 1H), 7.37-7.32 (m, 1H), 7.28-7.17 (m, 5H), 7.01-6.93 (m, 3H), 6.39 (q, 1H, J=1.6 Hz), 3.15 (s, 3H), 3.14 (d, 1H, J=22.2 Hz), 2.73 (d, 1H, J=22.8 Hz), 1.86-1.84 (m, 3H), 1.32 (s, 9H).

### Lithium 7-(o-biphenyl)-5-tert-butyl-6-methoxy-2-methylindenide

To a precooled, stirring solution of 7-(o-biphenyl)-5-tert-butyl-6-methoxy-2-methylindene (0.964 g, 2.62 mmol) in diethyl ether (50 mL), n-butyllithium (1.00 mL, 2.74M in hexane, 2.74 mmol, 1.05 equiv.) was added. The reaction was stirred at room temperature overnight. The reaction was concentrated under a stream of nitrogen and then under high vacuum. The residue was washed with hexane (10 mL) and filtered over a plastic, fritted funnel. The filtered solid was collected and concentrated under high vacuum to afford the product as a white solid (0.748 g, 76% yield). ¹H NMR (400 MHz, C4D8O): δ 7.72-7.65 (m, 1H), 7.41-7.37 (m, 1H), 7.33-7.27 (m, 2H), 7.08 (s, 1H), 7.07-7.02 (m, 2H), 6.93-6.87 (m, 3H), 5.69 (d, 1H, J=6.0 Hz), 5.51 (d, 1H, J=2.1 Hz), 3.08 (s, 3H), 2.28 (s, 3H), 1.10 (s, 9H).

### (4-(o-Biphenyl)-6-(tert-butyl)-5-methoxy-2-methylindenyl)dimethyl(2,3,4,5-tetramethyl cyclopentadienyl)silane

To a stirring solution of lithium 7-(o-biphenyl)-5-tert-butyl-6-methoxy-2-methylindenide (0.748 g, 2.00 mmol) in diethyl ether (50 mL), tetramethylcyclopentadienyldimethylsilyl trifluoromethanesulfonate (0.656 g, 2.00 mmol, 1 equiv.) was added. The reaction was stirred at room temperature for 2 hours. The reaction was concentrated under a stream of nitrogen and then under high vacuum. The residue was extracted with pentane (3×20 mL) and filtered over Celite. The combined pentane extracts were concentrated under a stream of nitrogen and then under high vacuum to afford the product as a white foam (1.07 g, 98% yield). ¹H NMR (400 MHz, C6D6): Isomers integrated in total, δ 7.68-7.63 (m, 1H), 7.59-7.54 (m, 1H), 7.53-7.46 (m, 4H), 7.32-7.23 (m, 8H), 7.10-6.93 (m, 6H), 6.59 (s, 1H), 6.49 (s, 1H), 3.60 (s, 1H), 3.53 (s, 1H), 3.25-3.17 (m, 5H), 3.11 (s, 3H), 2.04 (s, 3H), 2.02 (s, 6H), 1.95 (s, 6H), 1.88 (s, 3H), 1.85 (s, 3H), 1.84 (s, 3H), 1.81 (s, 6H), 1.36 (s, 9H), 1.32 (s, 9H), −0.13 (s, 3H), −0.19 (s, 3H), −0.21 (s, 3H), −0.23 (s, 3H).

### Dimethylsilyl (4-(o-biphenyl)-6-tert-butyl-5-methoxy-2-methylindenyl) (2,3,4,5-tetramethylcyclopentadienyl) zirconium dichloride (Catalyst E2)

To a stirring solution of (4-(o-biphenyl)-6-(tert-butyl)-5-methoxy-2-methylindenyl)dimethyl(2,3,4,5-tetramethylcyclopentadienyl)silane (1.07 g, 1.95 mmol) in diethyl ether (50 mL), n-butyllithium (1.5 mL, 2.74M in hexane, 4.1 mmol, 2.1 equiv.) was added. The reaction was stirred at room temperature for 70 minutes. The reaction was concentrated under a stream of nitrogen and then under high vacuum to give a tan-brown solid. The solid was dissolved in diethyl ether (50 mL) and stirred, and zirconium chloride (0.455 g, 1.95 mmol, 1 equiv.) was added, washing residual zirconium chloride into the reaction with toluene (5 mL). The reaction was stirred at room temperature for 15 hours. The reaction was concentrated under a stream of nitrogen and then under high vacuum. The residue was extracted with dichloromethane (50 mL, then 2×10 mL) and filtered over Celite. The combined dichloromethane extracts were concentrated under a stream of nitrogen and then under high vacuum. The residue was stirred in pentane (10 mL). The resulting suspension was filtered over a plastic, fritted funnel. The filtered solid was collected and concentrated under high vacuum to afford the product as a yellow solid (0.962 g, 70% yield). ¹H NMR (400 MHz, CD₂Cl₂): δ 7.94-7.87 (m, 1H), 7.49-7.40 (m, 3H), 7.31 (s, 1H), 7.09-7.01 (m, 3H), 6.95-6.89 (m, 2H), 6.60 (s, 1H), 3.26 (s, 3H), 2.24 (s, 3H), 2.06 (s, 3H), 1.99 (s, 3H), 1.90 (s, 3H), 1.83 (s, 3H), 1.18 (s, 3H), 1.10 (s, 3H), 0.99 (s, 9H).

### Preparation of dimethylsilyl (4-(3,5-di-tert-butyl-4-methoxyphenyl)-6-tert-butyl-5-methoxy-2-methylindenyl) (2,3,4,5-tetramethylcyclopentadienyl) zirconium dichloride (Catalyst E4) 5-Tert-butyl-7-(3,5-di-tert-butyl-4-methoxyphenyl)-6-methoxy-2-methyl indene

To a sealable flask, 7-bromo-5-tert-butyl-6-methoxy-2-methylindene (0.916 g, 3.26 mmol), 3,5-di-tert-butyl-4-methoxyphenylboronic acid (0.870 g, 3.29 mmol, 1 equiv.), potassium carbonate (1.04 g, 7.50 mmol, 2.3 equiv.), bis(dibenzylideneacetone)palladium (0.020 g, 0.035 mmol, 0.01 equiv.), 1,3,5,7-tetramethyl-6-phenyl-2,4,8-trioxa-6-phosphaadamantane (0.030 g, 0.10 mmol, 0.03 equiv.), and tetrahydrofuran (30 mL) were added. Then, nitrogen-bubbled water (10 mL) was added. The sealable flask was put under a nitrogen atmosphere for 30 minutes, and then the flask was sealed. The sealed flask was stirred and heated to 80° C. for 19 hours. The reaction was then allowed to cool to room temperature. The contents of the flask were transferred to a separate flask and concentrated in vacuo. The residue was partitioned between water (50 mL) and diethyl ether (50 mL). The aqueous layer was drained, and the diethyl ether layer was collected. The aqueous layer was extracted further with diethyl ether (50 mL). The combined diethyl ether extracts were washed with brine (50 mL). The organic extract was dried over anhydrous magnesium sulfate and concentrated in vacuo to give an orange solid. The solid was dissolved in isohexanes (100 mL) and filtered over a pad of silica. The product was further washed through the silica pad with additional isohexanes (2×50 mL). The combined filtrate was concentrated in vacuo to afford the product as a white solid (1.36 g, 96% yield). ¹H NMR (400 MHz, C6D6): δ 7.55 (s, 2H), 7.38 (s, 1H), 6.46 (q, 1H, J=1.5 Hz), 3.47 (s, 3H), 3.25 (s, 3H), 3.14 (s, 2H), 1.85 (d, 3H, J=1.5 Hz), 1.60 (s, 9H), 1.49 (s, 18H).

### Lithium 4-(3,5-di-tert-butyl-4-methoxyphenyl)-6-tert-butyl-5-methoxy-2-methylindenide

To a precooled, stirring solution of 7-(3,5-di-tert-butyl-4-methoxyphenyl)-5-tert-butyl-6-methoxy-2-methylindene (1.36 g, 3.14 mmol) in diethyl ether (50 mL), n-butyllithium (1.30 mL, 2.74M in hexane, 3.56 mmol, 1.1 equiv.) was added. The reaction was stirred at room temperature for 30 minutes. The reaction was concentrated under a stream of nitrogen and then under high vacuum. The residue was washed with hexane (20 mL) and filtered over a plastic, fritted funnel. The filtered solid was collected and concentrated under high vacuum to afford the product as a white solid (1.30 g, 94% yield). ¹H NMR (400 MHz, C4D8O): δ 7.69 (s, 2H), 7.15 (s, 1H), 5.72 (dd, 1H, J=2.1, 0.7 Hz), 5.65 (d, 1H, J=2.1 Hz), 3.72 (s, 3H), 3.15 (s, 3H), 2.30 (s, 3H), 1.48 (s, 18H), 1.42 (s, 9H).

### (4-(3,5-di-tert-butyl-4-methoxyphenyl)-6-(tert-butyl)-5-methoxy-2-methylindenyl) dimethyl(2,3,4,5-tetramethylcyclopentadienyl)silane

To a stirring solution of tetramethylcyclopentadienyldimethylsilyl trifluoromethanesulfonate (0.972 g, 2.96 mmol, 1 equiv.) in diethyl ether (20 mL), lithium 4-(3,5-di-tert-butyl-4-methoxyphenyl)-5-tert-butyl-6-methoxy-2-methylindenide (1.30 g, 2.96 mmol) in diethyl ether (50 mL) was added. The reaction was stirred at room temperature for 1 hour. The reaction was concentrated under a stream of nitrogen and then under high vacuum. The residue was extracted with pentane (40 mL, then 20 mL) and filtered over Celite. The combined pentane extracts were concentrated under a stream of nitrogen and then under high vacuum to afford the product as a white foam (1.79 g, 98% yield). ¹H NMR (400 MHz, C6D6): δ 7.77 (s, 2H), 7.63 (s, 1H), 6.79 (s, 1H), 3.62 (s, 1H), 3.49 (s, 3H), 3.28 (s, 3H), 3.21 (br s, 1H), 2.03 (s, 3H), 1.98 (s, 3H), 1.90 (s, 3H), 1.82 (s, 6H), 1.64 (s, 9H), 1.54 (s, 18H), −0.08 (s, 3H), −0.18 (s, 3H).

### Dimethylsilyl (4-(3,5-di-tert-butyl-4-methoxyphenyl)-6-tert-butyl-5-methoxy-2-methylindenyl) (2,3,4,5-tetramethylcyclopentadienyl) zirconium dichloride (Catalyst E4)

To a stirring solution of (4-(3,5-di-tert-butyl-4-methoxyphenyl)-6-(tert-butyl)-5-methoxy-2-methylindenyl)dimethyl(2,3,4,5-tetramethylcyclopentadienyl)silane (1.79 g, 2.92 mmol) in diethyl ether (50 mL), n-butyllithium (2.2 mL, 2.74M in hexane, 6.0 mmol, 2.1 equiv.) was added. The reaction was stirred at room temperature for 67 minutes. The reaction was concentrated under a stream of nitrogen and then under high vacuum to give a foam. The foam was dissolved in diethyl ether (50 mL) and stirred, and zirconium chloride (0.679 g, 2.91 mmol, 1 equiv.) was added, washing residual zirconium chloride into the reaction with toluene (5 mL). The reaction was stirred at room temperature for 15 hours. The reaction was concentrated under a stream of nitrogen and then under high vacuum. The residue was extracted with dichloromethane (50 mL, then 20 mL) and filtered over Celite. The combined dichloromethane extracts were concentrated under a stream of nitrogen and then under high vacuum. The residue was stirred in hexane (40 mL). The resulting yellow suspension was filtered over a plastic, fritted funnel. The filtered solid was collected and concentrated under high vacuum to afford the product as a yellow solid (1.589 g, 70% yield). ¹H NMR (400 MHz, CD₂Cl₂): δ 7.88-7.11 (m, 3H), 6.61 (s, 1H), 3.72 (s, 3H), 3.30 (s, 3H), 2.21 (s, 3H), 2.05 (s, 3H), 1.99 (s, 3H), 1.90 (s, 3H), 1.88 (s, 3H), 1.44 (s, 18H), 1.36 (s, 9H), 1.19 (s, 3H), 1.08 (s, 3H).

High Throughput polymerization Conditions: Unless stated otherwise, propylene homopolymerizations and ethylene-propylene copolymerizations (if any) were carried out in a parallel, pressure reactor, as generally described in U.S. Pat. Nos. 6,306,658; 6,455,316; 6,489,168; WO 2000/009255; and Murphy et al. (2003) J. Am. Chem. Soc., v. 125, pp. 4306-4317, each of which is fully incorporated herein by reference for US purposes. Although the specific quantities, temperatures, solvents, reactants, reactant ratios, pressures, and other variables may have changed from one polymerization run to the next, the following describes a typical polymerization performed in a parallel, pressure reactor.

Propylene Polymerization with Metallocene: A pre-weighed glass vial insert and disposable stirring paddle were fitted to each reaction vessel of the reactor, which contains 48 individual reaction vessels. The reactor was then closed and propylene was introduced to each vessel as a condensed gas liquid (typically 1 mL) Then solvent (typically the isohexane) was added to bring the total reaction volume, including the subsequent additions, to 5 mL and the reactor vessels were heated to their set temperature (usually from about 50° C. to about 110° C.). The contents of the vessel were stirred at 800 rpm. An activator solution (typically 100-1000 molar equivalents of methyl alumoxane (MAO) in toluene) was then injected into the reaction vessel along with 500 microliters of toluene, followed by a toluene solution of catalyst (typically 0.50 mM in toluene, such as 20-40 nmol of catalyst) and another aliquot of toluene (500 microliters).

Equivalence is determined based on the mol equivalents relative to the moles of the transition metal in the catalyst complex. The reaction was then allowed to proceed until a pre-determined amount of pressure had been taken up by the reaction. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC (see below) to determine the molecular weight and by DSC (see below) to determine melting point.

### Preparation of Silica Supported MAO (SMAO)

In a celstir, 10.0 g of 200° C. calcined silica (DM-L403, AGC Chemicals) was suspended in ca 100 mL of dry toluene and cooled in the freezer to −20° C. After ca 30 minutes of cooling, a 30% solution of MAO (15.8 g in toluene) was slowly added to the stirring silica mixture (over 10 minutes). The reactions were allowed to warm up to room temperature with stirring for 1.5 hours. After 1.5 hours, the temperature was raised to 100° C. and the reaction was allowed to stir for additional 2.5 hours. The temperature was then decreased down to 55° C. and the mixture was then filtered over glass frit. The collected SMAO was then washed with toluene 2×50 mL and pentane 2×50 mL and was dried in vacuo for 1 hour. Yield: 14.1 g of free flowing powder with calculated MAO absorption=7.1 mmol/g.

### General Procedure for Catalyst Supportation

0.51 g of SMAO was suspended in 10 mL of toluene. While stirring, a solution of TIBAL (0.260 mL of 1 M) was added. The mixture was further stirred for 15 minutes at room temperature. After 15 minutes, 8.2 μmol of desired metallocene was slowly added as a toluene solution (in ca 1-2 mL toluene). The mixture became green, and slowly turned dark red. Each mixture was stirred for 2.5 hours at room temperature. After 2.5 hours, the mixture was filtered, the supported catalyst was washed with toluene (2×5 mL) and pentane (2×5 mL) and dried in vacuo to afford supported metallocenes as dark orange/red powders.

### Test Methods

### ¹³C-NMR Spectroscopy

Polymer microstructure was determined by 13C-NMR spectroscopy, including the concentration of isotactic and syndiotactic diads ([m] and [r]), triads ([mm] and [rr]), and pentads ([mmmm] and [rrrr]). Samples were dissolved in d2-1, 1, 2, 2-tetrachloroethane. Spectra were recorded at 125° C. using a NMR spectrometer of 75 or 100 MHz. Polymer resonance peaks are referenced to mmmm=21.8 ppm. Calculations involved in the characterization of polymers by NMR follow the work of F. A. Bovey in “Polymer Conformation and Configuration” Academic Press, New York 1969 and J. Randall in “Polymer Sequence Determination, 13C-NMR Method”, Academic Press, New York, 1977. The percent of methylene sequences of two in length, % (CH2)2, were calculated as follows: the integral of the methyl carbons between 14-18 ppm (which are equivalent in concentration to the number of methylenes in sequences of two in length) divided by the sum of the integral of the methylene sequences of one in length between 45-49 ppm and the integral of the methyl carbons between 14-18 ppm, times 100. This is a minimum calculation for the amount of methylene groups contained in a sequence of two or more since methylene sequences of greater than two have been excluded. Assignments were based on H. N. Cheng and J. A. Ewen, Makromol. Chem. 1989, 190, 1931.

### Rapid GPC Procedure:

To determine molecular weight related values by GPC, high temperature size 5 exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388, each of which is fully incorporated herein by reference for US purposes. This apparatus has a series of three 30 cm×7.5 mm linear columns, each containing PLgel 10 m, Mix B. The GPC system was calibrated using polystyrene standards ranging from 580-3,390,000 g/mol. The system was operated at an eluent flow rate of 2.0 mL/minutes and an oven temperature of 165° C. 1,2,4-trichlorobenzene was used as the eluent. The polymer samples were dissolved in 1,2,4-trichlorobenzene at a concentration of 0.1-0.9 mg/mL. 250 μL of a polymer solution was injected into the system. The concentration of the polymer in the eluent was monitored using an evaporative light scattering detector (as shown by the examples in Table 3) or Polymer Char IR4 detector. The molecular weights presented are relative to linear polystyrene standards and are uncorrected.

### DSC Procedure

For the high throughput samples, the melting temperature (Tₘ) was measured using Differential Scanning Calorimetry (DSC) using commercially available equipment such as a TA Instruments TA-Q200 DSC. Typically, 5 to 10 mg of molded polymer or plasticized polymer is sealed in an aluminum pan and loaded into the instrument at about room temperature. Samples were pre-annealed at about 220° C. for about 15 minutes and then allowed to cool to about room temperature overnight. The samples were then heated to about 220° C. at a heating rate of about 100° C./min, held at this temperature for at least about 5 minutes, and then cooled at a rate of about 50° C./min to a temperature typically at least about 50° C. below the crystallization temperature. Melting points were collected during the heating period.

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the present technological advancement have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise, whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art. Any of the values in the tables can provide the end points for ranges that define their respective measurement or property, with an additional +/−10%.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

While the present disclosure has been described with respect to a number of embodiments and examples, those skilled in the art, having benefit of this disclosure, will appreciate that other embodiments can be devised which do not depart from the scope and spirit of the present disclosure.

1. A catalyst compound represented by Formula (I): 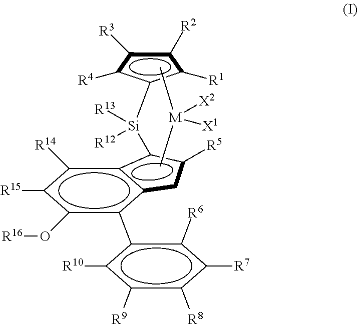
wherein,
M is a Group 4 metal;
each of X¹ and X² is a univalent anionic ligand, or X¹ and X² are joined to form a metallocycle ring;
R¹-R⁴ is each independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′2, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R⁵ is hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R⁶—R¹⁰ is each independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R¹⁴ and R″ each independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is independently hydrogen, halogen, C₁-C₁₀ alkyl, or C₆-C₁₀ aryl;
R¹² and R¹³ are each independently an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is independently hydrogen, halogen, C₁-C₁₀ alkyl, or C₆-C₁₀ aryl;
optionally, R¹² and R¹³ may be joined; and
R¹⁶ is an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —R″—SiR′₃, wherein R″ is C₁-C₁₀ alkyl and each R′ is independently hydrogen, halogen, C₁-C₁₀ alkyl, or C₆-C₁₀ aryl.

2. The catalyst compound of claim 1, wherein the catalyst compound includes one or more of the following:

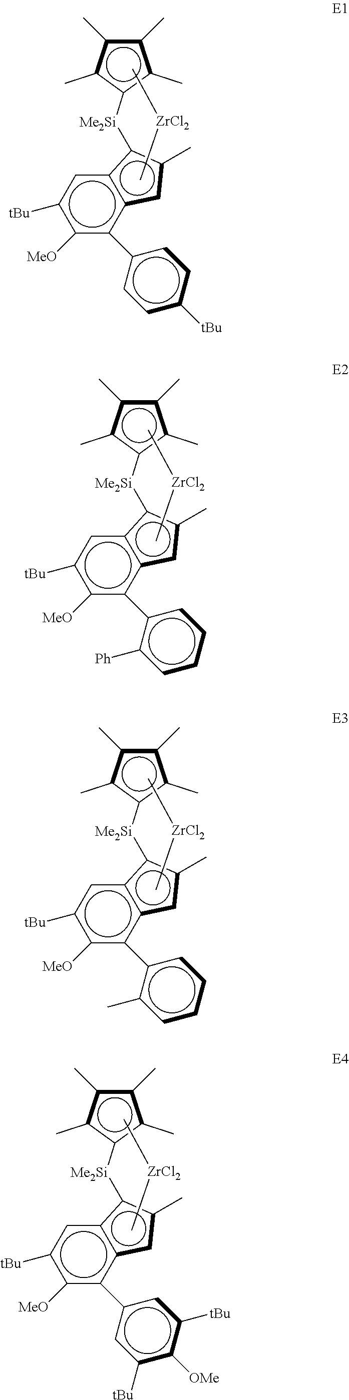

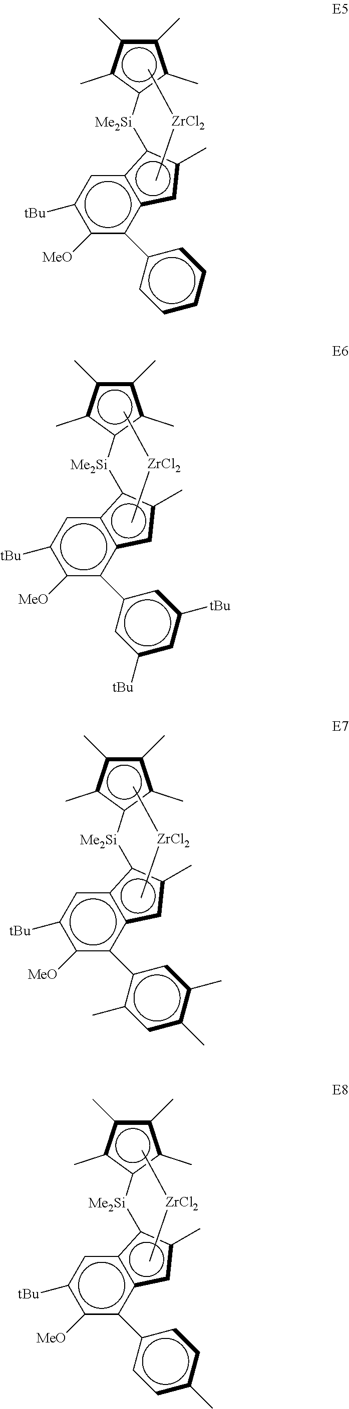

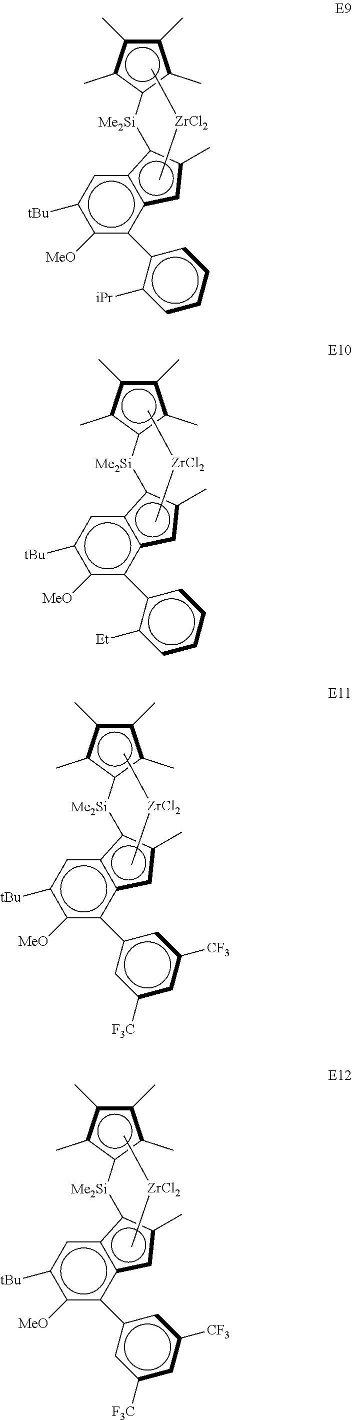

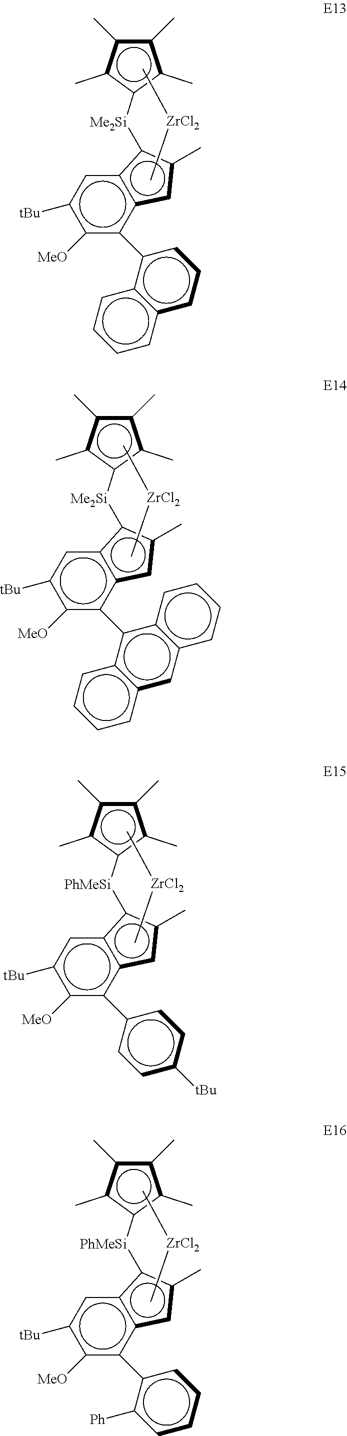

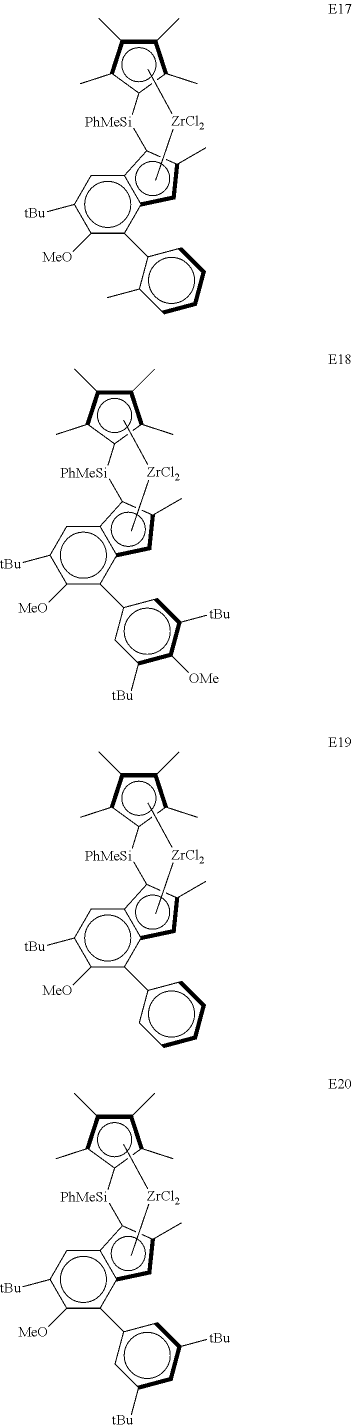

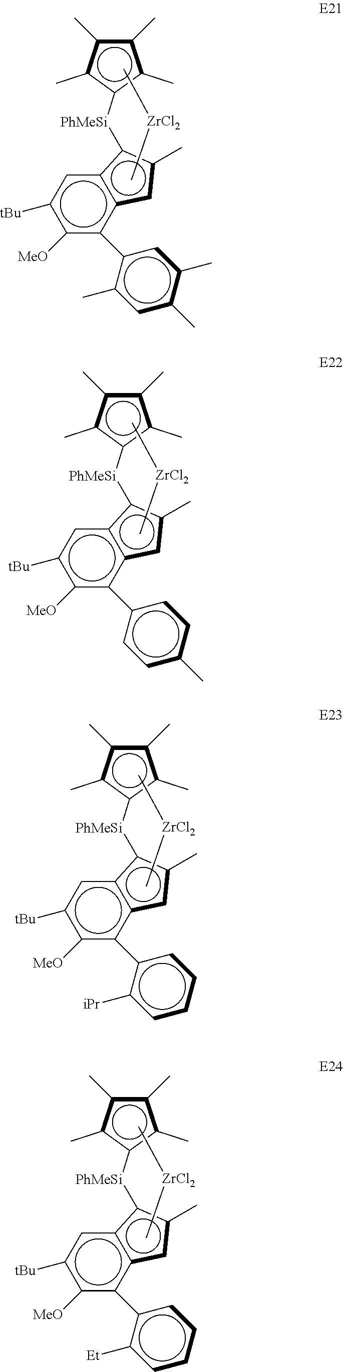

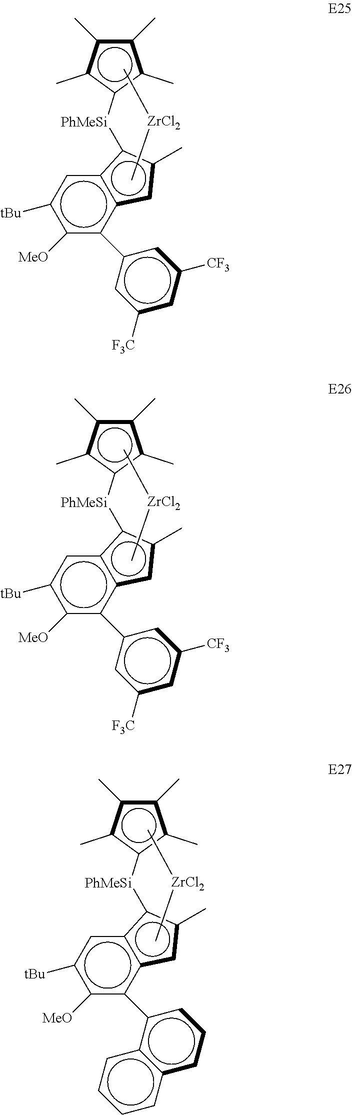

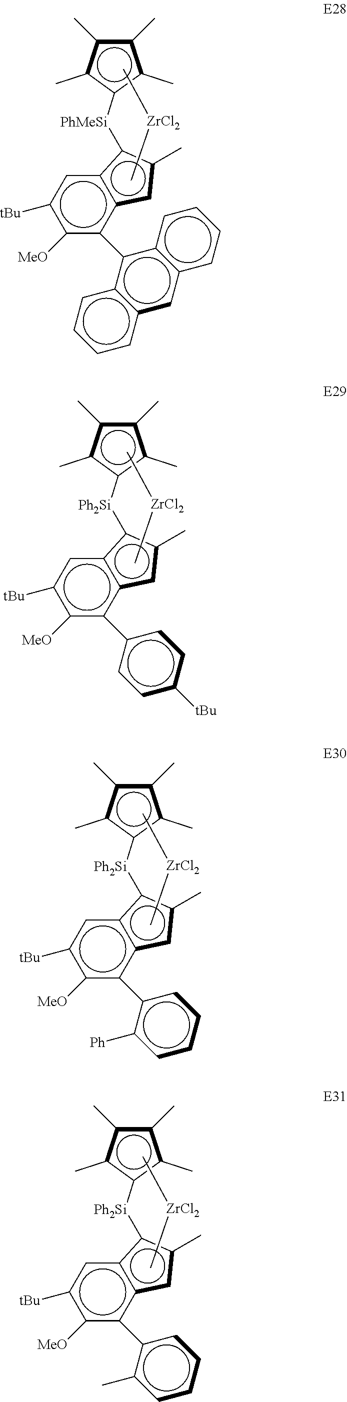

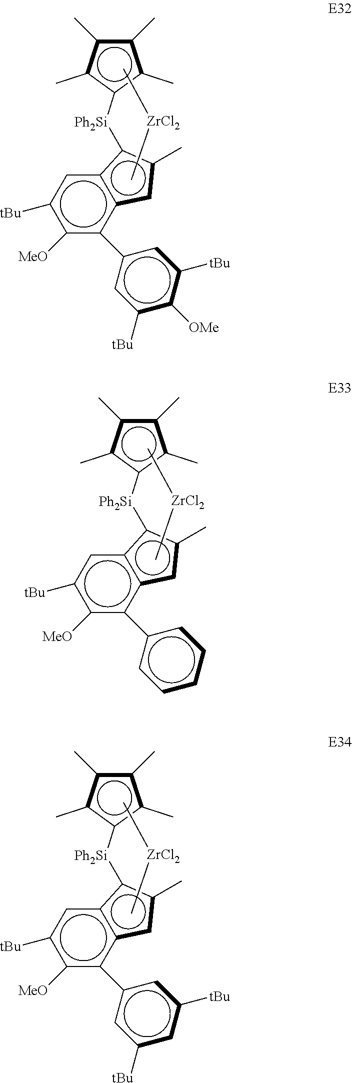

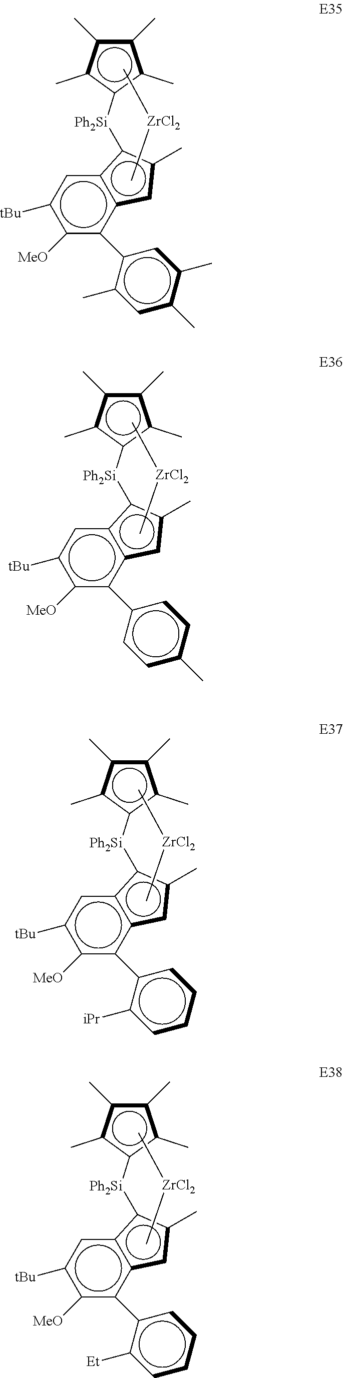

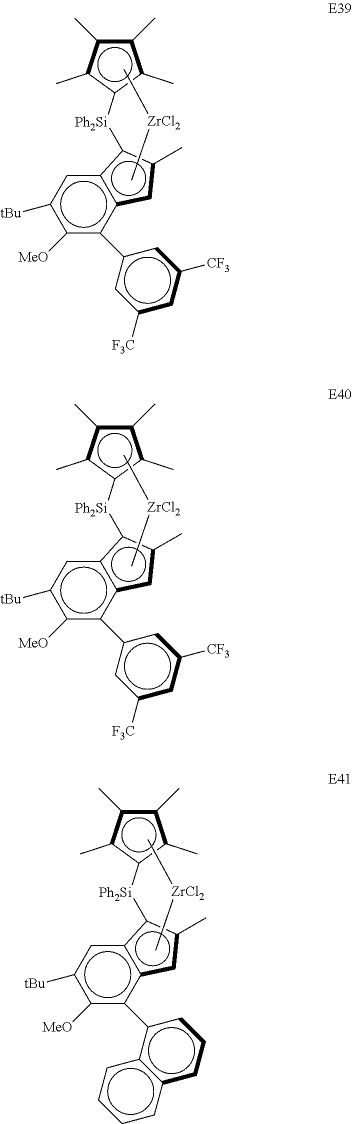

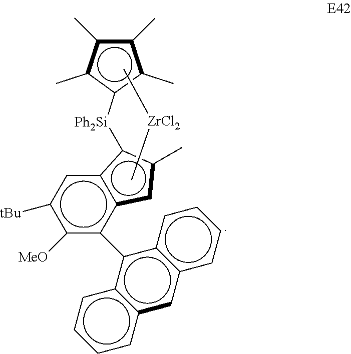

3. A catalyst system, comprising: the catalyst compound of claim 1; and an activator.

4. The catalyst system of claim 3, wherein the activator comprises methylalumoxane.

5. A process to prepare isotactic polypropylene comprising contacting propylene with the catalyst system of claim 3 and obtaining isotactic polypropylene.

6. A process to prepare a copolymer, comprising contacting ethylene and ethylene-octene with the catalyst system of claim 3 and obtaining a polyethylene/ethylene-octene copolymer.

7. A process to prepare a copolymer, comprising contacting ethylene and propylene with the catalyst system of claim 3 and obtaining an ethylene-propylene copolymer.

8. A process to prepare an alpha olefin homopolymer or copolymer by:
introducing one or more of a C₂-C₄₀ olefin monomer, and a catalyst system of claim 3, and optionally hydrogen into a reactor at a reactor pressure of from 0.7 bar to 70 bar and a reactor temperature of from 20° C. to 150° C.; and
obtaining an alpha olefin homopolymer or copolymer.

9. The process of claim 8, wherein the C₂-C₄₀ comonomer consists of ethylene, propylene 1-butene, 1-pentene, 1-hexene, 2-methyl-1-pentene, vinylcyclobutane, 1-heptene, 1-octene, 1-decene, 1-dodecene, 1-tetradecene, 1-hexadecene, 1-octadecene, 1,5-hexadiene, 1,7-octadiene and 1,9-decadiene, norbornene, vinylnorbornene or ethylidine norbornene.

10. The process of claim 8, wherein the olefin homopolymer or copolymer has a Mw value of 1,000 to 1,000,000 g/mol as measured by gel permeation chromatography.

11. The process of claim 8, wherein the olefin homopolymer or copolymer has a Mw distribution with polydispersity index less than 10.

12. The process of claim 8, wherein the olefin monomer is propylene.

13. The process of any one of claims 8 to 11, wherein the propylene homopolymer and copolymer each has a melting point of greater than 120° C.

14. The process of claim 8, wherein copolymer is an ethylene-propylene co-polymer with a comonomer content of 0.1-99.9 wt %.

15. The process of claim 8, wherein the co-polymer is an ethylene-linear alpha olefin co-polymer with linear alpha olefin content comonomer content of 0.1-50 wt %.
